(19) United States
(12) Patent Application Publication
(10) Pub. No.: US 2025/0265140 A1
(43) Pub. Date: Aug. 21, 2025

(54) METHOD AND APPARATUS FOR GENERATING AN ARTIFICIAL INTELLIGENCE (AI) MODEL ASSOCIATED WITH TENSOR DATA VERIFICATION AND CLASSIFICATION

(71) Applicant: Marvell Asia Pte Ltd, Singapore (SG)

(72) Inventors: Ulf Hanebutte, Gig Harbor, WA (US); Nikhil Bernard John Stephen, Sunnyvale, CA (US); Senad Durakovic, Palo Alto, CA (US)

(21) Appl. No.: 19/054,609

(22) Filed: Feb. 14, 2025

Related U.S. Application Data
(63) Continuation-in-part of application No. 19/043,343, filed on Jan. 31, 2025.
(60) Provisional application No. 63/554,685, filed on Feb. 16, 2024.

(51) Int. Cl. G06F 11/07

(52) U.S. Cl. CPC G06F 11/079; G06F 11/0706

(57) ABSTRACT

A system includes a machine learning (ML) accelerator running a first code generated by a first compiler that generates a first plurality of tensors associated with one or more ML operations of a ML model. The system includes a processor that receives the first and the second plurality of tensors associated with the ML model. The second plurality of tensors is generated by a second code generated by a second compiler running on a hardware executing the one or more ML operations of the ML model. The processor generates a plurality of relative errors associated with the first and second plurality of tensors. The processor calculates an order of magnitude associated with the first plurality of tensors. The processor extracts features from the plurality of relative errors and the plurality of order of magnitude values and generates the error classification model based on the one or more features.

### RELATED APPLICATION

This application claims the benefit and priority to U.S. Provisional Application No. 63/554,685 that was filed on Feb. 16, 2024, which is incorporated herein by reference in its entirety. Moreover, this application is a continuation in part application and claims the benefit and priority to the U.S. Nonprovisional application Ser. No. 19/043,343 that was filed on Jan. 31, 2025, which is incorporated herein by reference in its entirety.

### BACKGROUND

Use and implementations of machine learning (ML) and artificial intelligence (AI) methods on electronic devices has become ubiquitous. The design of a hardware architecture of the electronic devices, which can be but is not limited to a processor, a programmable logic, a dedicated hardware such as application specific integrated circuit (ASIC), or a dedicated ML hardware, often goes through various optimization and compilation processes.

A compilation process or a compiler generates low-level executable instructions (in binary) from one or more high-level code and identifies hardware resources to execute the low-level executable instructions. The compilation process may include quantization, reduction in mathematical precision, mapping of the application (e.g., a neural network) to a specific number of processing tiles of the hardware. In general, the compiler maps data, e.g., the network tensor weight, the network tensor bias constants, the network tensor input and output for each network layer, etc., to particular memories and generates the executable code associated therewith. For example, the compiler decides on which processing tile and which processing unit of the tile of a multi-core system will be processing certain data. As another example, the compiler may decide that certain data is to be processed by a central processing unit as opposed to a tile within a ML hardware.

In order to perform an inference run of a ML model on a ML-specific hardware (e.g., a hardware-based ML/AI accelerator) and/or a general-purposed CPU, a binary file (e.g., a set of target specific low-level instructions and/or model-specific data sections) has to be generated. In some embodiments, these models may be represented as (model) graphs containing many nodes (i.e. layers) which are operating on large multi-dimensional tensors.

A need has arisen to compare performance or validation of one or more hardware executing its respective compiler to perform one or more ML operation associated with a ML model together. For example, data generated by a first compiler being executed on one hardware to perform one or more ML operations of a ML model may be compared to a reference data (e.g., verified data) that may be generated by a second compiler being executed on another hardware (or the same hardware) to perform the same ML operations of the ML model in order to verify whether the data generated by the first compiler executed on the one hardware to perform the one or more ML operations of the ML model is correct.

ML models generally include many layers and may generate very large number of intermediate as well as final data. For example, tensors in ML models are generally very large, e.g., millions of values, and comparing millions of values is not only a daunting task but, in many scenarios, impossible on a layer-by-layer basis. As such, conventionally, many systems only use a subset of derived values of the final output, e.g., top 1 or top 5 classifications, of the final output. While this approach may be a valid approach for the overall model delivering expected results within an expected accuracy level, it may not be sufficient to verify the performance of a ML computation to ensure that the ML computation is accurate and does not contain bugs and further to verify that hardware is executing each operation correctly. Additionally, the comparison of the final output in the conventional manner, while may reveal whether the values are close to one another, it does not provide any insight into potential causes for a mismatch between the values generated from a target system to a reference system.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system to support comparing a target system generated tensors to a reference system generated sensors in accordance with some embodiments.

FIGS. 2A-2C depict examples of network of ML model, splitting of graphs to sub-graphs by the compiler, and transforming the formatting of the data according to one aspect of the present embodiments.

FIG. 3A shows a generated graph according to one aspect of the present embodiments and FIG. 3B shows an output file according to one aspect of the present embodiments.

FIGS. 4A-4D depict examples of a two-dimensional graph of relative errors for tensors versus order of magnitude according to one aspect of the present embodiments.

FIG. 5A depicts an example of a system configured to generate a ML model to classify errors using data associated with relative errors for tensors and order of magnitude according to one aspect of the present embodiments.

FIG. 5B depicts an example of a system configured to use the generated ML model to classify errors associated with tensors generated by a target system according to one aspect of the present embodiments.

FIGS. 6A-6B depict examples of a two-dimensional graph of relative errors for tensors of two compilers versus order of magnitude according to one aspect of the present embodiments.

FIGS. 7A-7C depict examples of a two-dimensional graph of relative errors for tensors of two compilers versus order of magnitude according to another aspect of the present embodiments.

FIGS. 8A-8B depict examples of a two-dimensional graph of relative errors for tensors of two compilers versus order of magnitude according to yet another aspect of the present embodiments.

FIGS. 9A-9B depict examples of a two-dimensional graph of relative errors for tensors of two compilers versus order of magnitude according to even another aspect of the present embodiments.

FIGS. 10A-10B depict examples of a two-dimensional graph of relative errors for tensors of two compilers versus order of magnitude according to yet other aspects of the present embodiments.

FIGS. 11A-11B depict examples of a two-dimensional graph of relative errors for tensors of two compilers versus order of magnitude according to some aspects of the present embodiments.

FIGS. 12A-12C depict examples of a two-dimensional graph of relative errors for tensors of two compilers versus order of magnitude according to some other aspect of the present embodiments.

FIGS. 13A-13C depict examples of a two-dimensional graph of relative errors for tensors of two compilers versus order of magnitude according to yet some other aspects of the present embodiments.

FIGS. 14A-14B depict examples of a two-dimensional graph of relative errors for tensors of two compilers versus order of magnitude according to yet another aspect of the present embodiments.

FIGS. 15A-15B depict examples of a two-dimensional graph of relative errors for tensors of two compilers versus order of magnitude according to another nonlimiting aspect of the present embodiments.

FIGS. 16A-16B depict examples of a two-dimensional graph of relative errors for tensors of two compilers versus order of magnitude when performing a certain ML operation according to one aspect of the present embodiments.

FIGS. 17A-17C depict relative errors for output of tensor data associated with layer 29 of a large network in FP16 in comparison to reference system FP32 and its order of magnitude in accordance with some embodiments.

FIGS. 18A-18B depict relative error distribution for different order of magnitude limits.

FIG. 19 depicts a flowchart of an example of processing tensor values and generating order of magnitude associated with relative errors of the tensor values according to one aspect of the present embodiments.

FIG. 20 depicts a flowchart of an example of generating a model to classify errors associated with a ML operation using data associated with relative errors for tensors and order of magnitude according to one aspect of the present embodiments.

FIG. 21 depicts a flowchart of an example of applying a generated model to classify errors associated with a ML operation using data associated with relative errors for tensors and order of magnitude according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

In general, a compiler is configured to go through multiple levels or stages during compilation of high-level code into low-level executable instructions on a hardware. At each level (i.e. stage), the compiler needs to make one or more decisions on compilation, e.g., how to map the data to be processed and to which memory blocks, decision on a particular processing tile to execute the executable code for a particular data, etc. It is appreciated that references to level of backend compiler (discussed later in the application) refers to stages of compilation by the backend compiler. At each level, the compiler in addition to generating the low-level executable code may also generate multi-layered structured metadata for that stage that reflects the action(s)/decision(s) being made by the compiler, e.g., mapping of data to memory blocks, precision, quantization, processing tile to perform a particular task/instruction, dimension reordering, copying across processing tiles, etc. It is appreciated that the compiler action(s)/decision(s) occur first in order for the high-level code to be compiled into low-level executable instructions.

It is appreciated that the number of hardware units and their respective compilers compiling a ML model and its respective operations into low-level executable codes have increased. For example, some may use a general processing unit (CPU) and its compiler to compile a given ML model into low-level executable codes while others may use an accelerator (e.g., ML hardware) and its respective compiler to compile the same ML model into low-level executable codes. There is a need to compare performance and/or validation of data from different hardware units with their respective compilers compiling the same ML model into low-level executable codes with one another. For example, one may wish to compare the results of a ML model being executed by a hardware (e.g., a central processing unit, a field programmable gate array (FPGA), an application specific integrated circuit (ASIC), ML hardware, graphics pipeline unit (GPU), etc.) and its compiler that is considered as the reference data (hereinafter refers to reference system) to the same ML model being executed by a different hardware unit (or the same hardware unit) having a different compiler (hereinafter referred to as target system). In other words, one may wish to verify the accuracy of a target system operating on a ML model to that of a reference system by comparing the data generated by each system.

In some cases, ML models are generally very large and complex in nature. For example, ML models may be provided as graphs containing many nodes (e.g., layers, operators, etc.) that operate on large multi-dimensional tensors. In one nonlimiting example, a tensor in a ML application may be a multidimensional array that organizes and represents data. In one nonlimiting example, a tensor in the ML application may represent high-order relationships to discover hidden patterns in data that would otherwise not be discoverable. In yet another nonlimiting example, a tensor may map between higher order tensors to improve the performance and generalization of models to make the tensors more robust. It is appreciated that the tensors may be generated at each layer and due to their complexity and large nature (e.g., millions of values) of the tensors in ML models, it is very difficult if not impossible to compare each tensor at a desired layer generated by a reference system to the tensors generated by the target system. Accordingly, in one conventional approach one may use the final output (e.g., one or more tensors output from operating on a ML model) by a reference system to the final output by a target system or data derived from the final output, e.g., Top1 value, Top5 value, etc., generated by the target system. While this approach may be used to verify that the overall model being executed by the target system generates results that are within the expected accuracy level, it may not be sufficient to verify that the performed ML computation is accurate, e.g., bugs associated with the code, hardware executing each operation correctly, etc. For example, error may propagate from one layer to the next and either reduce the ultimate error associated with the output or it may exacerbate the error by being cumulative.

Accordingly, a need has arisen to enable tensors generated by a target system operating on a ML model to be compared to tensors generated by a reference system operating on the same ML model. The tensors may be from any layer of the ML model (e.g., intermediate layers as well as final output layer) and are not limited to the final output.

Additionally, there is a need to not only verify the accuracy of data being generated by a target system but also to automatically determine the causes of mismatch (or errors) between data from different systems, e.g., between the target system and the reference system. Identifying the causes of mismatch (e.g., classification of errors) enables one to address those issues. For example, one or more ML models (e.g., using convolutional neural network (CNN)) may be generated associated with error classifications, e.g., synchronization errors, loading wrong values (e.g., bias values), incorrect padding (described in greater detail below), serialization problems (described in greater detail below), clipping issues (described in greater detail below), incorrect handling of integer quantization format type (e.g., 10000000 in int8 should be interpreted as −128 whereas in uint8 it should be interpreted as 128), scaling issues that causes overflow/underflow issues (described in greater detail below), wrong memory mapping (e.g., transmission of wrong data from on-chip memory (OCM) to a double data rate (DDR)), etc. Once the one or more ML models are generated, data (e.g., comparison between tensors from the target system and reference tensors in accordance with order of magnitude (OOM), as described in greater detail below) may be fed in and the one or more generated ML models are applied to classify the data, e.g., data matching, error types, etc. Application of the generated ML models to the comparison data identifies a source of problem, e.g., decision made by the compiler, etc., associated with the target system and therefore may be remedied.

It is appreciated that different hardware units or the same hardware unit with different compilers generate tensors that may have a different value for a number of different reasons, e.g., order of performing one or more ML operation, different between precision associated with the reference system as opposed to the target system, etc. For example, in order to achieve low latency and/or high throughput, an accelerator may be used to compile the ML model which may utilize lower precision (e.g., use of floating point (FP) 16 as opposed to FP32, etc.) for the target system in comparison to the reference system that may use a higher precision such as FP32. Similarly, in order to achieve low latency and/or high throughput, an accelerator may be used to compile the ML model which may utilize a different quantization for the target system in comparison to the reference system. While values associated with tensors being generated vary and fall within a wide range of values, many of the tensor elements have a value close to zero or zero value, which is one of the characteristics of ML models in general. As such, even small deviations between values that are close to zero result in large relative errors when tensors generated by the reference system is compared to tensors generated by the target system. For example, in FP32 operations 32 bit are used with 23 bits of significand and precision of approximately 7-9 decimal digits while in half-precision such as FP16, 16 bits are used with significand 10 bits and precision of approximately 3-4 decimal digits. The small deviation resulting from use of FP16 as opposed to FP32 may result in large relative errors when the values are close to zero, as an example. Large relative errors on its face may be construed as a problem associated with the target system. However, information with respect to the value being close to zero one may be used to conclude that the large relative error is due to deviation (e.g., resulting from dealing with different precision such as FP16 as opposed to FP32) that appears as a large relative error when dealing with close to zero values. It is appreciated that a relative error may be a measure of uncertainty of a measurement compared to the size of the measurement itself. According to one nonlimiting example, the relative error may be calculated as the absolute error divided by the true value and may be expressed as a percentage. It is appreciated that a relative error is a representation of significance of an error in relation to the correct value. In one nonlimiting example, a relative error may be calculated as absolute error divided by a true value and multiplied by 100% to represent it as a percentage value.

As described above, a need has arisen to compare tensor values generated by the target system that are generated by the reference system and further to determine whether a larger relative error is due to a problem associated with the target system, e.g., bug in the code, compiler issues (e.g., memory allocation, synchronization, data access, lower-level instruction calls, serialization problems, clipping, incorrect handling of integer quantization format type, scaling issues, incorrect memory mapping, etc.), lower-level library failing to generate the correct code, improper zero padding by the compiler, orientation (dimension reordering), splitting or copying (data/ML operations) across processing tiles, improper loading of bias values due to serialization problem, improper loading of coefficients due to serialization problem, etc., or whether the larger relative error is due to something more innocuous such as use of different precision in the target system in comparison to the reference system. Accordingly, potential issues or problems associated with the target system, e.g., compiler, lower-level library, underlying target hardware, etc., can be identified and addressed to improve performance and accuracy of the target system.

A new approach is proposed for comparing a target system generated tensors to a reference system generated tensors. In one nonlimiting example, the relative errors between the tensors generated by the target system and the reference system are calculated. In one nonlimiting example, the order of magnitude values associated with the tensors of the reference system are calculated. The tensors of the reference system may graphically be rendered by their order of magnitude and relative errors associated with the target system. As such, tensors with large order of magnitude (values that are close to zero), e.g., order of magnitude greater than 100, may be discarded from consideration of verification of the target system against the reference system because large order of magnitude indicates close to zero values and smallest deviations caused by for example using a different precision, quantization, etc., may generate a large relative error. As such, the focus may be shifted to a subset of tensors from the generated tensors with smaller order of magnitude, e.g., order of magnitude less than or equal to 100. Large relative errors associated with tensors with small order of magnitude may be a reflection of certain issues/problems (causing failures) associated with the target system, e.g., bug in the code, compiler issues (e.g., memory allocation, synchronization, data access, lower-level instruction calls, etc.), lower-level library failing to generate the correct code, zero padding by the compiler, orientation (dimension reordering), splitting or copying (data/ML operations) across processing tiles, etc. Accordingly, remedial actions, e.g., updating the code, revising the zero padding by the compiler, splitting/copying across processing tiles, synchronization, generation of code for lower-level library, etc., may be taken to address any potential issues associated with the target system. As such, the new approach moves away from old data matching methodology that takes into consideration only the absolute difference between two sources of data to generate a pass/fail and instead considers the order of magnitude range to determine if output is within the order of magnitude range and if not, then the data is discarded from consideration.

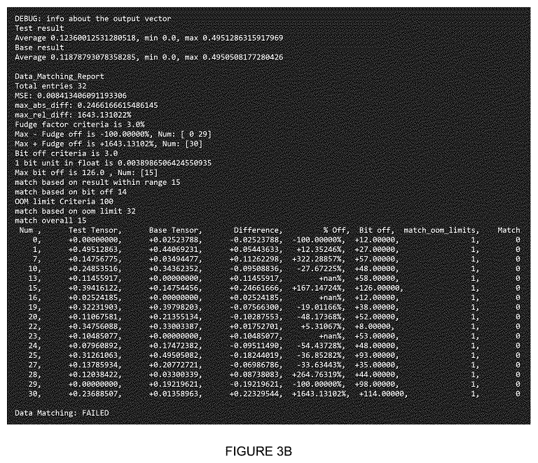

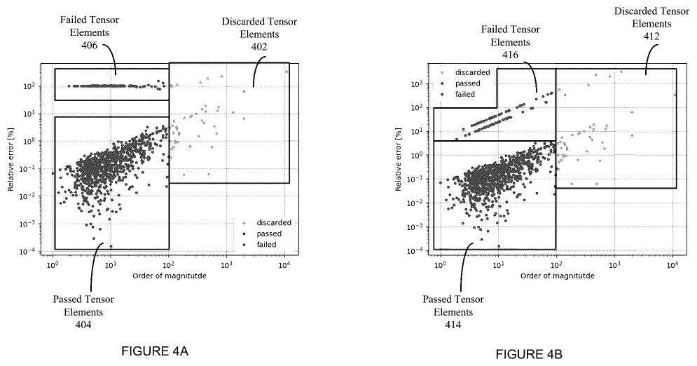

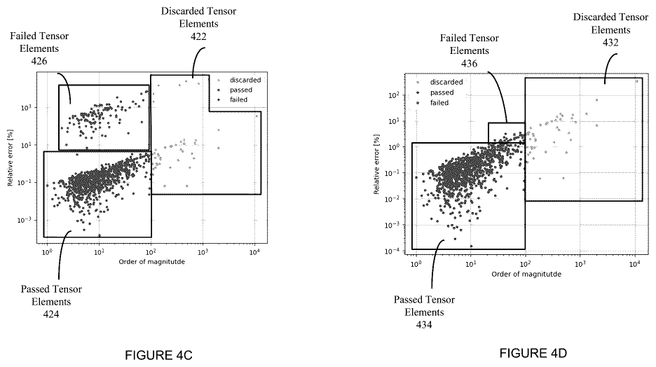

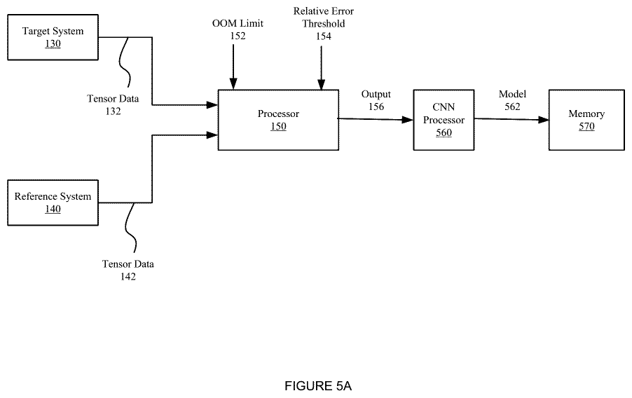

It is appreciated that according to some embodiments, one or more ML models may be generated associated with different types of errors. For example, data (e.g., tensors) generated by a reference system may be compared (using order of magnitude) to data generated by a target system where the wrong bias values are loaded, as described in FIG. 4B below. As illustrated, a ML model may be generated to identify the pattern associated with incorrect loading of bias values. The generated ML model associated with loading of incorrect bias values may be used when the tensor data of the target system is being compared to the reference system (order of magnitude) to determine whether the target system is loading the correct or incorrect bias values. In other words, the data generated by the target system may be classified with errors, e.g., loading of incorrect bias values. As yet another nonlimiting example, data (e.g., tensors) generated by a reference system may be compared (using order of magnitude) to data generated by a target system where improper padding of data with zeros has occurred, as described in FIG. 4A below. As illustrated, a ML model may be generated to identify the pattern associated with incorrect zero padding. The generated ML model associated with incorrect zero padding may be used when the tensor data of the target system is being compared to the reference system (order of magnitude) to determine whether the target system is applying incorrect zero padding. In other words, the data generated by the target system may be classified with errors, e.g., incorrect zero padding. It is appreciated that other types of ML models may also be generated for a number of other errors, as described above. Thus, ML models may be applied to the comparison of data between the target system and the reference system to identify errors (classify errors) within the target system. Accordingly, appropriate remedial actions may be taken, e.g., modifying the compiler to adjust the padding, modifying the synchronization to load the proper bias values, etc. ML model generation and application to identify issues and to classify errors within a target system is described in greater detail with respect to FIGS. 5A-5B.

It is appreciated that one or more components of the system may run on one or more computing units or devices (not shown) each with software instructions stored in a storage unit such as a non-volatile memory of the computing unit for practicing one or more processes. When the software instructions are executed, at least a subset of the software instructions is loaded into memory by one of the computing units, which becomes a special purposed one for practicing the processes. The processes may also be at least partially embodied in the computing units into which computer program code is loaded and/or executed, such that, the computing units become special purpose computing units for practicing the processes. For nonlimiting examples, the compiler may take certain actions and make certain decisions to reduce one or more of data movement, data conversions, storage usage, computation (or duplication of computation), and communication (by duplicating compute if beneficial), etc. The ML hardware may be a dedicated hardware including one or more microprocessors and/or OCM units storing the data and/or the set of low-level instructions compiled from the high-level code by the compiler to perform one or more ML operations. At runtime, the ML hardware is configured to retrieve the set of low-level instructions and/or data from the compiler and execute the set of low-level instructions to perform the one or more ML operations according to the set of low-level instructions. For a nonlimiting example, the ML-specific hardware can be but is not limited to an inference engine, which is configured to infer and identify a subject via an inference operation from data input according to the ML network model.

Although an instruction set architecture (ISA) is used as a nonlimiting example of the low-level instruction format to illustrate the proposed approach in the embodiments described below, it is appreciated that the same or similar approach is equally applicable to other types of low-level instructions. It is also appreciated that a ML hardware (e.g., inference engine) is used as a nonlimiting example of the hardware where the low-level instructions are executed to illustrate the proposed approach in the embodiments described below, it is appreciated that the same or similar approach is equally applicable to other types of hardware or hardware simulator to support generating a metadata using a compiler that can ultimately be used for verification, debugging, and optimization purposes. Moreover, it is appreciated that a ML-related operation or function is used as a nonlimiting example of the application of the high-level code to illustrate the proposed approach in the embodiments described below, it is appreciated that the same or similar approach is equally applicable to other types of software applications including but not limited to firmware, hardware simulation software, or register transfer level (RTL) simulation software, to support the compiler generating a metadata.

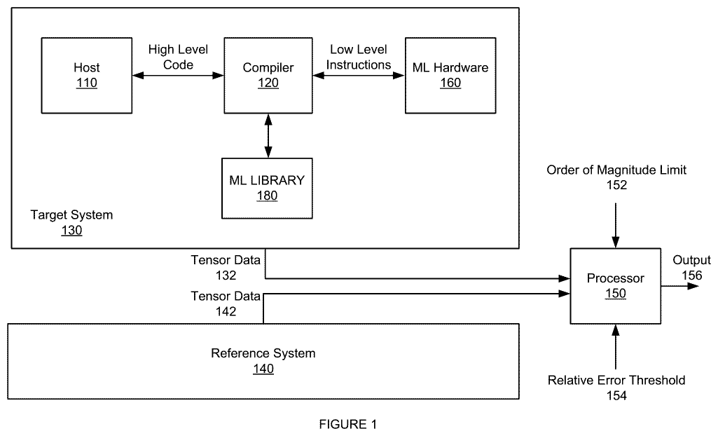

FIG. 1 depicts an example of a diagram of a system to support comparing a target system generated tensors to a reference system generated sensors in accordance with some embodiments. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, a target system 130 generates tensor data 132 associated with one or more ML operations from one or more layers of a ML model. It is appreciated that the compilation of the ML model by the target system 130 is described in greater detail below. Similarly, the reference system 140 may generate tensor data 142 associated with the one or more ML operations from one or more layers of the same ML model as the one as the target system 130. It is appreciated that the hardware executing the ML model for the reference system 140 may be the same or different from that of the target system 130. However, the compiler associated with the target system 130 is different from the compiler of the reference system 140. For example, the target system 130 may use FP16 for its operations associated with the ML model but the reference system 140 may use FP32 for its operations associated with the ML model. The generated tensor data 132 from the target system 130 and the generated tensor data 142 from the reference system 140 are transmitted to a processor 150, e.g., a CPU, an FPGA, an ASIC, an accelerator, etc., for processing.

The processor 150 is configured to generate an order of magnitude values associated with the tensor data 132. In one nonlimiting example, the order of magnitude may be normalization value associated with the tensors. In one nonlimiting example, the order of magnitude may be a logarithmic calculation, e.g., log₁₀, etc. In yet another nonlimiting example, order of magnitude may be calculated as a maximum of absolute value of a reference tensor divided by the absolute value of the tensor being compared. As yet another example, order of magnitude may be calculated as a root-mean-square value of a reference tensor divided by the absolute value of the tensor being compared. According to some embodiments, for a given reference data element of the tensor data 142 that is not a zero value the order of magnitude may be calculated as the absolute value of the largest value in tensor data 142 divided by the given reference data element of tensor data 142 that is not a zero value. For a given reference data element of the tensor data 142 that is a zero value and if a given target data element of the tensor data 132 is not a zero value, then the order of magnitude may be calculated as the absolute value of the largest value in tensor 142 divided by the value of the given target data element of the tensor data 132 that is a nonzero value. Otherwise (when both the target data element of the tensor data 132 and the reference data element of the tensor data 142 are zeros), the order of magnitude may be calculated as the order of magnitude limit 152, e.g., 100 (meaning the smallest non-zero value is 100 times smaller than the largest observed value of output tensor), plus any number, e.g., 1, 2, 3, etc., to put those numbers out of range. For illustration purposes, the tensor data 142 may include a vector comprising [1.01, 1.2, 50, 0.3, 0, 0] and the tensor data 132 may include a vector comprising [1, 1.1, 42, 0.2, 0, 0.1]. Accordingly, the order of magnitude may be calculated as [49.5, 41.7, 1.0, 166.7, 101.0, 500.0]. It is appreciated that while values equal to or greater than 0 are shown the values may also be negative and which their absolute value may be used instead. As yet another nonlimiting example, the tensor data 142 may include a vector comprising [1.01, 1.2, −50, 0.002, 0, 0] and the tensor data 132 may include a vector comprising [1, 1.1, −42, 0.2, 0, 0.1]. Accordingly, the order of magnitude may be calculated as [49.5, 41.7, 1.0, 25000.0, 101.0, 500.0].

It is appreciated that the order of magnitude calculation provided is for illustration purposes and should not be construed as limiting the scope of the embodiments. For example, the second largest value (or any other anker point data) may be used instead of the large value, a log scale may be used, normalized value, etc. In other words, a spread of tensor values are generated through any mechanism through which the order of the magnitude can be compared to one another may be used.

Processor 150 may process the tensors 132 and 142 to calculate their relative errors. In one nonlimiting example, the tensors data 142 may be considered as the verified and therefore as the reference data. For example, in one example the tensor data 142 may be generated by, for nonlimiting examples, a Glow Interpreter FP32 (compiler for neural network hardware that is supported by deep learning frameworks like PyTorch), TVM Interpreter FP32 (open source machine learning compiler framework for CPUs, GPUs, and ML accelerators), Glow Interpreter FP16, TVM Interpreter FP16, Glow Interpreter Int8, etc. Once the relative errors are determined, the relative errors may be plotted against the order of magnitude. It is appreciated that the processor 150 may also receive the order of magnitude limit 152 that indicates how small of the values are to be considered, e.g., 100, 200, etc. Moreover, the processor 150 may receive the relative error threshold 154 that indicates what relative error is considered as pass and what is considered as fail. A nonlimiting example of a code for calculating order of magnitude and the relative error is shown below.

# Relative Error: (for reference = 0, diff set to NAN)
diff = np.where(reference_tensor == 0, np.where(test_tensor == 0, 0, np.nan), (test_tensor −
reference_tensor) / reference_tensor * 100)
# Match based on fudge_factor
exp_min = reference_tensor * (1.0 − np.sign(reference_tensor) * fgft)
exp_max = reference_tensor * (1.0 + np.sign(reference_tensor) * fgft)
match_rel_diff = (test_tensor <= exp_max) & (test_tensor >= exp_min)
# Match based on LIMIT:
OOM_LIMIT = 100
oom_reference.fill(OOM_LIMIT)
max_reference = np.max(np.abs(reference_tensos))
oom_reference = np.abs(max_reference / np.where(reference_tensor != 0.0, reference_tensor,
test_tensor))
match_oom_limits = oom_reference <= OOM_LIMIT
# Bit off match in case of int8/uint8 quantization
max_output = np.abs(test_tensor).max( )
divisor = 255 if output_type == “uint8” else 127 count_unit = max_output / divisor
bit_off = (np.ceil(np.abs(test_tensor − reference_tensor) / (count_unit / 2.0)) − 1)
bit_off = (test_tensor != reference_tensor) * bit_off
match_bit_off = bit_off <= delta
# Match results in case of fp16 quantization
match = match_oom_limits & match_rel_diff
# Match results in case of int8/uint8 quantization
match = (match_oom_limits & match_rel_diff) | match_bit_off

It is appreciated that the processor 150 may output 156 the order of magnitude versus the relative errors, as calculated, in a two-dimensional graph. For example, the processor 150 may render the two-dimensional graph on a display or may output and store a file containing the relative errors and the order of magnitude associated with the tensors 132. In one nonlimiting example, a line associated with the relative error threshold 154 and a line associated with the order of magnitude limit 152 may also be represented. Accordingly, a first subset of tensor values for the tensors 132 that are greater than the order of magnitude 152 are discarded (or graphically represented as being discarded) while a second subset of tensor values that are smaller than (or equal to) the order of magnitude 152 and have relative errors greater than the threshold relative error 154 are graphically represented as failure points, and while a third subset of tensor values that are smaller than (or equal to) the order of magnitude limit 152 and have relative errors less than (or equal to) the threshold relative error of 154 are graphically represented as passed points.

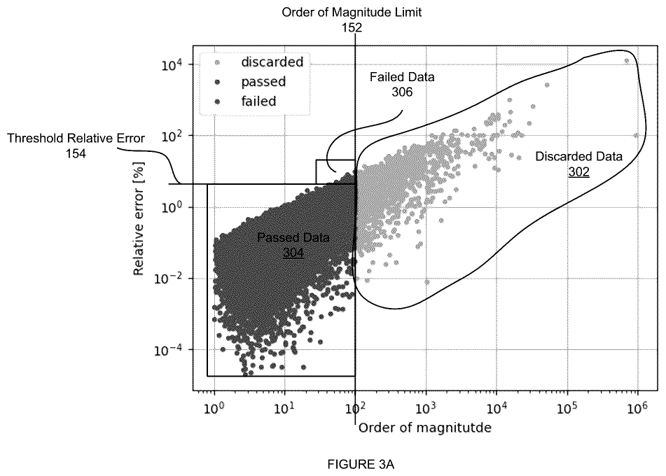

An example of a graph is illustrated in FIG. 3A. As illustrated in FIG. 3A, the tensor values that are greater than the order of magnitude limit 152 may be represented as the discarded 302 because small deviations for close to zero numbers may result in large relative errors and therefore can be discarded. In contrast, the tensor values that are less than the order of magnitude limit 152 and are smaller than the threshold relative error 154, e.g., 3%, are indicated as passed data 304. Moreover, the tensor values that are less than the order of the magnitude limit 152 and are greater than the threshold relative error 154 are indicated as failed data 306. In one nonlimiting example, the line associated with the order of magnitude limit 152 and the line associated with the threshold relative error 154 may not be displayed as part of the two-dimensional graph illustrating the relative errors versus order of magnitude.

It is appreciated that the generated information may be represented in any given fashion and its illustration as a graphical output is merely for illustration purposes and should not be construed as limiting the scope of the embodiments. For example, the information may be output 156 as a file where the first subset of tensor values is shown in a given column while the second and the third subset of tensor values are shown in other columns. In yet another example, the first subset of tensor values (tensor values that are greater than the order of magnitude limit 152) may be discarded. It is appreciated that the order of magnitude limit 152 and the threshold relative error of 154 may be user selectable and user modifiable. In other words, the graphical representation associated with the tensors may change (the discarded tensor values, the pass/fail, etc.) as the order of magnitude limit 152 and the threshold relative error of 154 are modified. An example of the output file is shown in FIG. 3B.

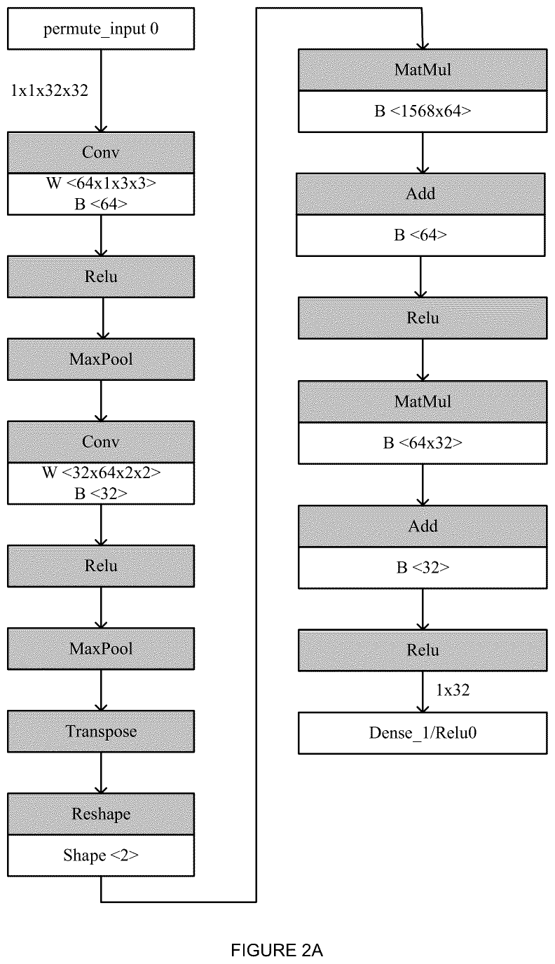

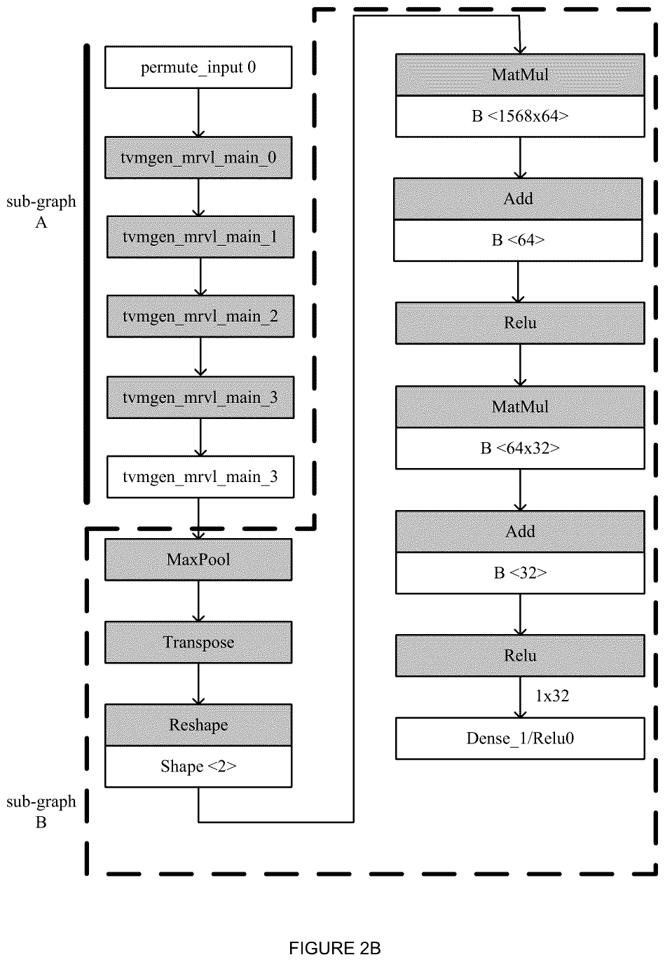

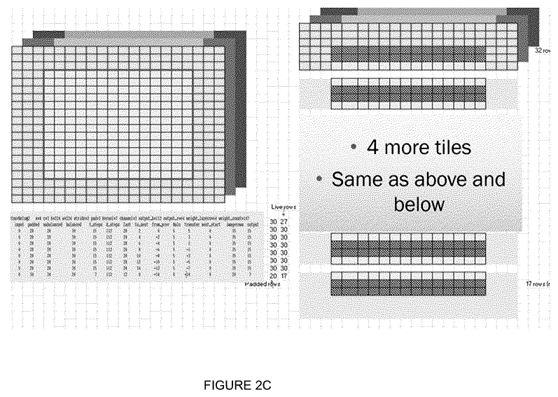

The interworking of the target system 130 is now described below and further with respect to FIGS. 2A-2C. It is appreciated that the reference system 140 may also include similar components as that of the target system 130 and may operate substantially the same but with different (or the same) hardware, different compiler, different precision, different quantization, etc.

The target system 130 includes a host 110, a compiler (compiling engine) 120, optionally a ML library 180, and a ML hardware 160. It is appreciated that one or more components of the system may run on one or more computing units or devices (not shown) each with software instructions stored in a storage unit such as a non-volatile memory of the computing unit for practicing one or more processes. When the software instructions are executed, at least a subset of the software instructions is loaded into memory by one of the computing units, which becomes a special purposed one for practicing the processes. The processes may also be at least partially embodied in the computing units into which computer program code is loaded and/or executed, such that, the computing units become special purpose computing units for practicing the processes.

In the example of FIG. 1, the compiler 120 coupled to a host 110 is configured to accept a high-level code of an application (e.g., a ML operation) from the host 110, wherein the high-level code includes a plurality of high-level functions/operators each called at one or more lines in the high-level code. It is appreciated that the host 110 may be part of the target system 130 (as illustrated) or separate therefrom. The compiler 120 is then configured to compile each high-level function/operator in the high-level code into a set of low-level instructions to be executed on the ML hardware 160, wherein each set of the low-level instructions is uniquely identified and associated with the high-level function. It is appreciated that the ML hardware 160 is provided for illustrative purposes and should not be construed as limiting the scope of the embodiments. For example, any type of hardware-based system configured to execute low-level instructions may be used.

Here, the high-level code is a software code written through a commonly-used high-level programming language. For a nonlimiting example, the high-level functions of the application or ML operation associated with the ML model can be a dense and/or regular operation, e.g., a matrix operation such as multiplication, matrix manipulation, tanh, sigmoid, etc. For another nonlimiting example, the high-level functions of the application or ML operation can be a sparse or irregular operation, e.g., memory transpose, addition operation, operations on irregular data structures (such as trees, graphs, and priority queues), etc. In some embodiments, the high-level code of the application may include one or more library function calls to a ML library 180. For a nonlimiting example, the compiler 120 may call a library function to perform a matrix-matrix-multiplication of two matrices of given sizes and the ML library 180 returns the set of low-level instructions that are needed to perform this library function, wherein the set of low-level instructions includes one or more of loading data from a memory (e.g., OCM) into registers, executing dot-product, and storing the data back into the memory.

In some embodiments, the set of low-level instructions are in the format of ISA designed for efficient data processing covering, for nonlimiting examples, one or more of different addressing modes, native data types, registers, memory architectures, and interrupts. In some embodiments, the ISA is a predominantly asynchronous instruction set, wherein each instruction in the ISA format programs a state-machine, which then runs asynchronously with respect to other state machines. It is appreciated that a series of instructions in the ISA format do not necessarily imply sequential execution. In some embodiments, the ISA provides separate synchronizing instructions to ensure order between instructions where needed. In some embodiments, when being executed on the ML hardware 160, the set of low-level instructions in the ISA format program the ML hardware 160 by one or more of: (i) programming one or more input data streams to the ML hardware 160; (ii) programming one or more operations to be performed on the input data streams; and (iii) programming one or more output data streams from the ML hardware 160.

In some embodiments, the compiler 120 is configured to generate additional information to further correlate the high-level function to one or more layers of a neural network used for machine learning applications. For nonlimiting examples, the neural network can be but is not limited to one of a CNN, a recurrent neural network (RNN), a gradient boosting machine (GBM), and a generative adversarial neural network. For nonlimiting examples, the additional information includes but is not limited to which tasks of the high-level function belong to a specific neural network layer as well as which neural network layer the high-level function belongs to.

Once the set of low-level instructions has been compiled from each high-level function, the compiler 120 is configured to stream the set of low-level instructions as well as data received from the host for the application to the ML hardware 160 for execution. In the example of FIG. 1A, the ML hardware 160 is a dedicated hardware block/component including one or more microprocessors and/or OCM units storing the data and/or the set of low-level instructions compiled from the high-level code performing one or more ML operations. For a nonlimiting example, the ML hardware 160 can be but is not limited to an inference engine running the ML model, which is configured to infer and identify a subject for the application via inference from trained data. At runtime, the ML hardware 160 is configured to retrieve the set of low-level instructions and/or data received from the compiler 120 and execute the set of low-level instructions to perform the high-level application/ML operation according to the set of low-level instructions. It is appreciated that in nonlimiting example where the ML hardware 160 is an inference engine, it may include a plurality of processing tiles, e.g., tiles 0, . . . , 63, arranged in a two-dimensional array of a plurality of rows and columns, e.g., 8 row by 8 columns. Each processing tile (e.g., tile 0) includes at least one OCM, a first type of processing unit (POD), and a second type of processing unit (PE). Both types of processing units can execute and be programmed by some of the plurality of low-level instructions received from the compiler 120. In some embodiments, a plurality of processing tiles forms a processing block, e.g., tiles 0-3 forms processing block 1 and the processing tiles within each processing block are coupled to one another via a routing element, e.g., tiles 0-3 are coupled to one another via routing element R to form processing block 1.

In order to generate the low-level instructions from high-level functions/code, the compiler 120 having knowledge of the ML hardware 160 architecture and software/system requirements makes certain decisions and performs certain operations in order to generate low-level instructions that are as efficient and as optimized as possible (e.g., from hardware perspective and/or software perspective). For example, the compiler 120 may take certain actions and make certain decisions to reduce data movement, to reduce data conversions, to reduce storage usage, to reduce computation (or duplication of computation), to reduce communication (by duplicating compute if beneficial), etc. A nonlimiting and non-exhaustive list of decisions being made by the compiler 120 in addition to the above includes but is not limited to:
identifying and associating certain sub-graphs of a layer to be processed by ML hardware 160 but other sub-graphs to other processing components (e.g., a central processing unit, GPU, ASIC, etc.),
fusing operators into composite to map to hardware ISA task (i.e. maps optimally to hardware architecture capabilities),
splitting input/output tensors of an operation into N parts where N may be the maximum number of tiles or smaller and distributing the parts across the N tiles. The parts may be of unequal sizes and the split input/output may duplicate the associated weights and bias tensors across all N tiles,
splitting weights/bias (similar to splitting input/output but applied to weights/bias),
SAMM/LAMM (different mappings of two matrices onto the POD registers based on the shape of the matrices and where SAMM indicates one dimension of the input being short whereas LAMM indicates one dimension of the input being long),
direct convolution (i.e. performing a convolution by directly applying the kernel to the input tensor in contrast to converting a convolution into a matrix-matrix-multiply that is executed after the input tensor is transformed by the flattening stage which results in an increased data movement and data duplication),
serializing in time (i.e. mapping an operation into a sequence of steps that are executed sequentially in time),
number of tiles to use for certain processing/tasks,
dividing tensors and duplicating on tiles (i.e. manner by which to map data to local tiles either distribute or copy or both, where a set of tiles may be grouped together and within the group the data may be split after the original data is duplicated or copied to each group),
number of halo cells (i.e. also referred to as ghost cells or rows that are added to distribute data on a tile which contains copies of rows or cells belonging to its neighboring tiles) that allows calculations on a tile be done locally without requiring data to be obtained from neighboring tiles even though it may need the halo cells/rows to be filled via communication prior to executing the calculations,
data movement,
rebalancing processing on different tiles,
memory hierarchy mapping,
determining tensor life-cycle (i.e. the amount of time that the tensor data is required to be in memory (mapped to local OCM) to ensure that the last task/instruction that needs to have access to the tensor data has access to the tensor data) in order to perform memory management and to free up unused memory,
quantization scaling values (i.e. the output of a certain layer in a quantized network may be rescaled to stay within a particular data range),
quantization data types (e.g., signed versus unsigned such as int8 and uint8),
rescaling,
determining which primitive to use for a given operator (e.g., direct convolution as opposed to flattening plus compute pipeline, complete fully connected (FC) layer (i.e. a matrix-matrix-multiply that might be performed as one distributed matrix-matrix-multiply (performed as single computation block followed by a single communication block) as opposed to being broken up into a pipeline sequence distributed matrix-matrix-multiplies which allows overlapping of communication and computation),
input to pipeline decisions (i.e. decision whether to apply a pipeline strategy, e.g., based on matrix sizes the optimal strategy may not be pipelined),
overlapping different hardware components, e.g., processing elements, direct memory access (DMA), etc., on ML hardware 160 to increase parallelism,
optimizing use of synchronization primitives
exposing and utilizing the ML hardware 160 capabilities for diverse set of workloads, e.g., ML workloads,
memory layout and conversion, as described in more detail in FIG. 1B, (e.g., in channel/height/width or height/width/channel format, etc.).

In one nonlimiting example, memory layout may be represented by channel, height, and width (CHW). In this nonlimiting example, for a quantized int8 network, each element of the weight matrix is an int8 value that is represented by 1 byte, however, in an fp16 network, 2 bytes per weight elements may be needed, as 2 bytes are needed to represent an fp16 value. In this nonlimiting example, the input of the OCM layout for layer 2 tensor is in CHW format. According to this nonlimiting example, there are 2 channels and the height and width are 5 bytes each. Accordingly, there are 2 blocks of 5×5 data. In this example, the system may require 8 bytes internally for alignment needed by the hardware. It is appreciated that, in some embodiments, the compiler 120 has knowledge of the architecture of the ML hardware 160 and its requirements, e.g., determining that conversion to HWC format is needed. As such, the compiler 120 may convert the format from CHW to HWC format. In this example, since the height is 5 then it is determined that there are 5 blocks of 5×2 since the width is 5 bytes and the channel is 2.

In this nonlimiting example, the compiler 120 may include a frontend compiler and a backend compiler. The frontend compiler may perform the analysis phase of the compilation by reading the source code, dividing the code into core parts and checking for lexical, grammar, and syntax. In some embodiments, the frontend compiler may include lexical analysis, syntax analysis, a semantic analysis, etc., and generates an intermediate data (also known as intermediate representation). The intermediate data may be input into the backend compiler in order to perform specific optimization and to generate the low-level instructions. It is appreciated that for ML compilers, the frontend compiler may include transformation from representation in one ML-framework (such as Keras) into another representation (such as ONNX standard). It is appreciated that the backend compiler may include multiple levels according to some embodiments. It is appreciated that the output from each level backend compiler is input to its subsequent level backend compiler. It is also appreciated that one or more of the level backend compilers may receive additional data from a source other than other level backend compilers.

In one nonlimiting example, the first level backend compiler receives the intermediate data and performs transformation/optimization, e.g., target specific fusing/composition, specific data/weigh/output layout format adjustment (an example of the data/weight/output layout format adjustment), target specific drop no operations, auto-layer identification in a subgraph, etc. It is appreciated that the output of the first level backend compiler is input to the second level backend compiler.

In some embodiments, the second level backend compiler in some nonlimiting examples performs a specific multi-layer based optimization (dividing ML operations into ML hardware layer subgraph and non-ML hardware layer subgraph to be executed by a component other than the ML hardware 160). It is appreciated that the backend compiler may also receive the target configuration for code generation in addition to receiving the output from the first level backend compiler. It is appreciated that the target configuration received during inference part of the ML operation can be used to determine the number of processing tiles to use, OCM base address and size, determining whether to pin all memory usages in OCM or not, determining whether to use special starting memory addresses, user received input on the strategy, determining whether to use int8 of fp16 or pre-quantized flow, etc. An example of the target configuration is provided below for illustration purposes and should not be construed as limiting the scope of the embodiments. It is appreciated that the target configuration describes both the hardware architecture specifics, e.g., arch type (MIK in this example), memory size (0x100000), etc., as well as specific compilation instructions, e.g., number of tiles to use such as 26 and the type of quantized network such as int8.

-max_layer=100000
-quantize=int8
-arch=m1k
-inp_quantized_to=uint8
-out_dequantized_from=uint8
-dram_addr_relocatable=1
-ocm_base=0x0
-ocm_size=0x100000
-num_tiles=26
-b=1
-future-be
-wb_pin_ocm=0
-dump_wb
-new_metadata
-ext_strategy_file=<name>

In some nonlimiting examples, the computation and data are moved by the compiler 120 from inference time to compiler time once in compilation in order to reduce computations and data movements at inference runtime. It is appreciated that the backend compiler may use a model, e.g., roofline model, given the target hardware configuration (i.e. ML hardware 160) and data layouts, at compilation time to estimate specific runtime performance. In some embodiments, the backend compiler may transform the layer subgraph to primitive subgraph where each of the primitives may describe a certain algorithmic procedures. In some embodiments, the primitives may perform only computational tasks, only communication tasks between tiles or between tiles and double data rate (DDR), only synchronization tasks, or any combination thereof. For example, the matrix-matrix-multiply primitives LAMM and SAMM are two different computational primitives that are optimized for different matrix shapes. While “all to all” is a communication primitive, as are halo, rebalance and forward gather which are primitives that perform data movements on distributed tensor data. An example of a combined communication and computation primitive is the flattening overlap. Examples of other algorithmic procedures may include MAXPOOL, direct convolution, padding, scratch, etc. The backend compiler determines mapping, resource allocation, and parallelism that may be applied on a layer by layer case. For example, the backend compiler may determine whether to split input/output on tiles, split weight/bias on tiles, combination of split input/output and weight/bias and serialization on tiles, overlap primitives on tiles, use LAMM as opposed to SAMM1/SAMM2 based on the manner in which the register files are used, apply direct convolution or flatten math multiplication (flattening followed by matrix-matrix multiply) or flattening matrix-matrix-multiply overlap based on layer configurations and layer format. In some nonlimiting examples, the backend compiler may also determine the number of tiles to use for a layer and the way to split data tensors and their computations among the tiles for that layer. The backend compiler may also determine whether to glue or rebalance and halo tensors or partial tensors and if so the manner of which to do so between different tiles of previous layer and tiles of the next layer. In some nonlimiting examples, the backend compiler may determine the manner by which to sync the rebalance tasks among the tiles, e.g., by applying local sync within a tile, global sync among tiles, barrier for all tiles, sync up between specific producer to specific consumer, etc. As synchronization steps are generally costly operations, different levels of synchronizations are supported by hardware that are often inserted judiciously by the compiler. For example, the PE and POD within a tile can be synchronized using a “local sync”, which is very light weight as opposed to a global sync among a group of tiles or all tiles that is much more costly. Additionally, synchronization primitives are provided that are optimized as they are limited to specific consumer/producer tiles of a given communication pattern. It is appreciated that in some embodiments, the backend compiler may determine the manner of which to reserve DDR and/or OCM memory regions for full or partial tensors to avoid read write data hazards (i.e. data corruption due to unintentional address reuse for optimization that has reused addresses), manner by which perform serialization, and manner by which to reduce data movement, etc. It is also appreciated that in some embodiments, the backend compiler may determine the manner of which to reserve DDR and/or OCM memory regions for full or partial tensors, to perform serialization and to reduce data movement. In some nonlimiting examples, the backend compiler may pipeline ISA tasks running on the same tile but different processing elements (i.e. PE versus POD) or on different tiles as determined from space-time analysis based on data allocations. Moreover, the backend compiler may generate primitive graphs for representing initial job, per-inference runtime job, and per-inference finishing job based on performance needs. Additionally, the backend compiler may use a primitive roofline model (e.g., given target hardware configuration (i.e., ML hardware 160)) at compilation time to estimate the ML hardware 160 specific runtime performance and once the final runtime performance statistics are collected the primitives may be calibrated and optimized.

It is appreciated that in some embodiments the backend compiler may receive data associated with a strategy indicated by a user (i.e. user strategy) in addition to receiving the output from the previous level backend compiler. It is appreciated that the strategy may be an external strategy generated by an analysis/profiling tool which is run external to the compiler flow. It is appreciated that in the following strategy, information for each layer of the fused graph is give. Details such as the type of operation, e.g., convolution or maxpool, the corresponding first and last ONNX operator of the original ONNX graph, the selected strategy and the externally provided strategy hints are given. For the first layer, in this example, the strategy of splitting the input and output among the tiles is applied while the weights and bias tensors are being duplicated. For this example, the hints are matching the applied strategy, but it does not need to be.

```
{ “file_type”: “ExtStrategy”,
  “layers”: [
    { “id”: 1, “op”: “CONV”, “to_layer_ids”: [ 2 ], “first_onnx_op”:
“resnetv17_conv0_fwd_transpose”, “last_onnx_op”: “resnetv17_relu0_fwd_{——}1”,
      “strategy_applied”: [ “split_io”, “dupl_wb” ],
      “external_strategy_hints”: [ “split_io”, “dupl_wb” ] }
    ,{ “id”: 2, “op”: “MAXPOOL”, “to_layer_ids”: [ 3, 4 ], “first_onnx_op”:
“resnetv17_pool0_fwd_{——}1”, “last_onnx_op”: “resnetv17_pool0_fwd_{——}1”,
      “strategy_applied”: [ “split_io” ],
      “external_strategy_hints”: [ “split_io” ] }
    , { “id”: 3, “op”: “CONV”, “to_layer_ids”: [ 7 ], “first_onnx_op”:
“resnetv17_stage1_conv3_fwd”, “last_onnx_op”:
“resnetv17_stage1_batchnorm3_fwd_{——}1”,
      “strategy_applied”: [ “split_io”, “dupl_wb” ],
      “external_strategy_hints”: [ “split_io”, “dupl_wb” ] }
    ,{ “id”: 4, “op”: “CONV”, “to_layer_ids”: [ 5 ], “first_onnx_op”:
“resnetv17_stage1_conv0_fwd”, “last_onnx_op”: “resnetv17_stage1_relu0_fwd_{——}1”,
      “strategy_applied”: [ “split_io”, “dupl_wb” ],
      “external_strategy_hints”: [ “split_io”, “dupl_wb” ] }
    ,{ “id”: 5, “op”: “CONV”, “to_layer_ids”: [ 6 ], “first_onnx_op”:
“resnetv17_stage1_conv1_fwd”, “last_onnx_op”: “resnetv17_stage1_relu1_fwd_{——}1”,
      “strategy_applied”: [ “split_io”, “dupl_wb”, “DIRECTCONV” ],
      “external_strategy_hints”: [ “split_io”, “dupl_wb” ] }
    ,{ “id”: 6, “op”: “CONV”, “to_layer_ids”: [ 7 ], “first_onnx_op”:
“resnetv17_stage1_conv2_fwd”, “last_onnx_op”:
“resnetv17_stage1_batchnorm2_fwd_{——}1”,
      “strategy_applied”: [ “split_io”, “dupl_wb” ],
      “external_strategy_hints”: [ “split_io”, “dupl_wb” ] }
    ,{ “id”: 7, “op”: “SUM”, “to_layer_ids”: [ 8, 11 ], “first_onnx_op”:
“resnetv17_stage1_{——}plus0_{——}1”, “last_onnx_op”: “resnetv17_stage1_activation0_{——}1”,
      “strategy_applied”: [ “split_io” ],
      “external_strategy_hints”: [ “split_io” ] }
    ,{ “id”: 8, “op”: “CONV”, “to_layer_ids”: [ 9 ], “first_onnx_op”:
“resnetv17_stage1_conv4_fwd”, “last_onnx_op”: “resnetv17_stage1_relu2_fwd_{——}1”,
      “strategy_applied”: [ “split_io”, “dupl_wb” ],
      “external_strategy_hints”: [ “split_io”, “dupl_wb” ] }
    ,{ “id”: 9, “op”: “CONV”, “to_layer_ids”: [ 10 ], “first_onnx_op”:
“resnetv17_stage1_conv5_fwd”, “last_onnx_op”: “resnetv17_stage1_relu3_fwd_{——}1”,
      “strategy_applied”: [ “split_io”, “dupl_wb”, “DIRECTCONV” ],
      “external_strategy_hints”: [ “split_io”, “dupl_wb” ] }
... ] }
```

Other level backend compilers may perform other operations and make other decisions. For example, other backend level compilers may perform functions based on specified attributes for the primitives, e.g., forming a set of common ML library and application peripheral interface (APIs), in order to generate ISA tasks codes to fulfill the need for all primitives for the ML hardware 160. In some nonlimiting examples, based on specified ML library APIs with their arguments, the particular level backend compiler may generate the appropriate ISA task codes to utilize the ML hardware 160 in a streaming fashion, as an example. It is appreciated that for each ML library API with its arguments, a per ML library API roofline model is used, at the time that the code is being generated, to estimate the target specific runtime performance and to monitor and check performance with respect to each ISA instruction, and/or to determine boundary violations (attributes that lead to memory wrap around or data hazard ISA instructions being produced due to memory address reuse). It is appreciated that at the time that the compiler calls the ML library API, the arguments to the library call have all the pertinent information regarding tensors and the arithmetical operations to be performed. Thus, a roofline model can be computed for this specific API call which will provide an estimate target specific runtime of these arithmetical operations. Accordingly, the compiler can iteratively decide on which API to call in cases where multiple different APIs are available to perform the same arithmetical operations. In some nonlimiting examples, other operations/decisions may include a model binary analyzer subcomponent that performs an overall analysis to identify potential problems in the low-level instructions (i.e. generate model binary), e.g., ill-formed OCM memory overlapping between ISA tasks/instructions, data hazard between consumer-producer tasks, etc.

The Nth level backend compiler in some nonlimiting examples performs ahead of time (AOT) inference on the ML hardware 160 accelerators and/or other processing units (e.g., CPU). In some examples, the Nth level backend compiler generates performance statistics for the inference run associated with the ML hardware 160. The Nth level backend compiler may decide on whether to perform AOT on the ML hardware 160, on its software emulator, or on a full machine emulator with the ML hardware 160 submodules. Based on the performance statistics, certain aspects of the system may be optimized, e.g., calibrate and optimize the generated code, the primitives, etc. It is appreciated that the Nth level backend compiler also generates the low-level instructions for execution by the ML hardware 160.

In this nonlimiting example, the ML hardware 160 (i.e., accelerator) may be integrated with a ML compiler 120 framework such as TVM that supports Bring Your Own Codegen (BYOC), thereby enabling the TVM ecosystem to become available to users of the ML hardware. In one nonlimiting example, the compiler 120 may be a proprietary compiler associated with the ML hardware 160 and is used to run a ML model and perform one or more ML operations to be compared by values (tensors) as provided as reference data by the reference system 140. In this nonlimiting example, the ML hardware 160 may be a ML/AI inference accelerator (MLIP) and may be embedded in a processor, e.g., CPU, GPU, field programmable gate array (FPGA), etc. In other words, the ML model, e.g., pre-trained network, that is received may be split across multiple devices, e.g., an accelerator (hereinafter ML hardware) and a general processor such as a CPU or GPU, etc. In one nonlimiting example, the ML model may be received (e.g., loaded) and processed by the frontend compilation and code-gen AOT.

An example of a pre-trained network of the ML model for illustrative purposes is shown in FIG. 2A and should not be construed as limiting the scope of the embodiments. In FIG. 2A, the pre-trained network of the ML model is a CNN model that is mapped to internal representation and to layers to be used by the compiler 120 to generate low-level instructions to be executed on the ML-specific hardware 160 and/or other general processors, e.g., CPU, GPU, FPGA, etc. The pre-trained network of the ML model may include a plurality (e.g., tens, hundreds, or thousands) of ML operations described in high-level code. In this nonlimiting example, the pre-trained model is a complex model such as ResNet50_SSD. It is appreciated that the high-level code may include a plurality of high-level functions/operators each called at one or more lines in the high-level code. For a nonlimiting example, a ML operation can be a dense and/or regular operation, e.g., a matrix operation such as multiplication, matrix manipulation, tanh, sigmoid, etc. For another nonlimiting example, a ML operation can be a sparse or irregular operation, e.g., memory transpose, addition operation, operations on irregular data structures (such as trees, graphs, and priority queues), etc. In some embodiments, the ML network model can be represented by a neural network used for ML applications, wherein the neural network can be complex and huge in size. For nonlimiting examples, the neural network can be but is not limited to one of a CNN, a RNN, a gradient boosting machine (GBM), and a generative adversarial neural network.

In some embodiments, the compiler 120 may process the received ML network model and identify a plurality of well-defined boundaries for input and output in the ML network model based on a set of primitives. It is appreciated that the set of primitives may refer to a set of functions, units, and/or operators that are basic, generic, and essential (in contrast to specialized) to the ML operations of the ML network model. It is appreciated that each of the primitives may invoke one or more library function calls to a ML library 180 to generate low-level instructions to be executed on a hardware. For a nonlimiting example, a library function may be called to perform a matrix-matrix-multiplication of two matrices of given sizes and the ML library returns the set of low-level instructions that are needed to perform this library function, wherein the set of low-level instructions includes one or more of loading data from a memory, e.g., OCM, into registers, executing dot-product, and storing the data back into the memory.

Once the plurality of well-defined boundaries is identified, the compiler 120 partitions the ML network model into a plurality of units/layers/graph/sub-graphs based on the plurality of well-defined boundaries. In some embodiments, the boundaries are defined by one or more leaf nodes of the graphs where each leaf node corresponds to an ending edge of a layer (which corresponds to one or more nodes) created by the compiler 120 by executing one or more primitive functions/operators on one or more hardware components. In some embodiments, the well-defined boundary of the layer corresponds to executing last primitive function/operator in a graph on the hardware components for the layer. In some embodiments, the functionality of this last primitive function/operator can also be mapped back to its corresponding one or more ML operations in the ML network model.

The compiler 120 then generates an internal/interim representation for each of the plurality of units/nodes of the graph. In this nonlimiting example a number of nodes are executable nodes of a ML layer. The compiler has knowledge of the architecture of the ML hardware, architecture of general processing units such as CPU, GPU, FPGA, etc., respective configurations, and software/system requirements etc. In some embodiments, the type of operations within a graph and/or the amount of processing/computation may be used to determine a hardware target selection, e.g., ML hardware 160 as opposed to a general processor. It is appreciated that the compiler 120 may split the original model graph into sub-graphs based on the type of operation and/or latency, as nonlimiting examples. In some embodiments, the compiler 120 may recognize operators (i.e., network layers) of the graph and whether the recognized operators are supported by the ML hardware 160 or not. Any operator of the graph that is unsupported by the ML hardware 160 may be flagged by the compiler 120 and partitioned into a sub-graph for execution by a general processor. In this nonlimiting example, the graph with executable nodes that are not supported or unsuited for execution on the ML hardware 160 are separated out for execution by a different processing unit, e.g., CPU. According to some embodiments, operators of the graph that are supported by the ML hardware 160 may still be partitioned and split into a sub-graph for execution by a general processor to reduce latency, data movement between two sub-graphs, etc. In other words, the compiler 120 may determine that unsupported operators/nodes that have been flagged along with some unflagged nodes should be split into a sub-graph for execution by a general processor to improve processing and achieve certain efficiencies, e.g., reduce data movement, reduce latency, etc. In some embodiments, the compiler 120 is configured to estimate the computing cost of each node (e.g., when executed on the ML hardware 160 as opposed to a general processor) and communication cost for data movement (e.g., between the ML hardware and the general processor). The compiler 120 may split the graph into sub-graphs based on the estimated computing cost, etc., in order to achieve certain efficiencies in processing the ML model. Operators that are supported by the ML hardware 160 and that can be executed efficiently by the ML hardware 160 are formed into a different sub-graph for execution by the ML hardware 160. It is appreciated that it may be desirable to split the graph into the least number of sub-graphs, e.g., 2 sub-graphs. The ML model regardless of how it may be split is executed by the target system 130 to generate the tensors 132.

In FIG. 2B, the backend compiler may make a determination to split the graph of nodes to two subgraphs, e.g., output of one sub-graph from a general processor to input of one sub-graph of a ML hardware 160 for example. In other words, the generated input/output node pairs to connect the sub-graphs is a representation of the original model graph. In some embodiments, one of the subgraph nodes will be executed by the ML hardware 160 while another subgraph nodes will be executed by a processing component other than the ML hardware 160, e.g., a CPU. As such, the internal representation of the sub-graph is mapped to the ML hardware 160 or ML software emulator and the internal representation of the other sub-graph is mapped to a general processor. The ML model that is split into sub-graphs is shown in FIG. 2E for illustration purposes and should not be construed as limiting the scope of the embodiments.

As described above, the ML hardware is a dedicated hardware including one or more microprocessors and/or OCM units storing the data and/or the first set of low-level instructions to perform the plurality of ML operations. The internal representation of sub-graph is mapped to one or more components in a general-purposed computing device (e.g., a general CPU or GPU), a special-purposed hardware (e.g., another (second) ML hardware that is different from the (first) ML-specific hardware), or a software simulator or emulator of a hardware, or a combination of the ML hardware and ML hardware emulator. In some embodiments, the ML hardware 160 and the general-purposed computing device may be separate devices even though they may be integrated on a same physical device.

It is appreciated that each sub-graph may be optimized. For example, the compiler may perform target specific transformations and optimizations on each sub-graph. It is appreciated that because the target associated with each sub-graph may be different, e.g., ML hardware, ML emulator, general processor, etc., their resources and/or architecture are also different, e.g., memory, processing units, etc. As such, each sub-graph may undergo a different transformation and/or optimization depending on the target that will be executing the code generated for the sub-graph. As such, the pre-trained ML model is processed in an efficient and optimized fashion.

It is appreciated that the embodiments for splitting the graph into subgraphs such that one subgraph is executed by the ML hardware and one subgraph is executed by a general processor is for illustrative purposes and should not be construed as limiting the scope of the embodiments. For example, the embodiments are equally applicable to splitting the graph into subgraphs where one subgraph is executed by a software emulator (emulation of ML hardware) and where the other subgraph is executed by a general processor. As such, discussions with respect to the subgraph being executed by the ML hardware is for illustrative purposes and should not be construed as limiting the scope of the embodiments. It is appreciated that in some embodiments, the subgraphs created for execution by ML hardware and the general processor may be compiled using the same compiler or by using different compilers.

Referring now to FIG. 2C, a nonlimiting example of a compiler receiving a first layer in CHW format and how it maps it to the tiles and performs the required padding according to some embodiments is shown. In some examples, the first layer is received as an input in CHW format and it may be transposed to HWC format (as described above) as part of the flattening process that is natural form for the POD. In this example, the size of the padding is 3 and the input is in CHW form for a batch size of 3×224×224. It is appreciated that in some embodiments, no flattening may be needed and as such the transpose might be needed as part of the output of the previous layer or as a separate step in the input layer. In this nonlimiting example, the slicing to map to the tiles is a batch of 8 across 64 tiles, each input is split across 8 tiles and is row-wise (i.e., <35, 35, 35, 35, 35, 35, 35, 19> for tiles <7, . . . , 0>.

Below is another example of a code that illustrates the input, the weight, and the bias constants and output for a fp16 network for illustration purposes. In this nonlimiting example, a convolution layer in a network that is reduced to fp16 precision is illustrated.
Layer 1: Conv
   Input [1]: float16, [batch, inC, H, W]=[1, 1, 32, 32]
   Weight: float16, [outC, inC, H, W]=[64, 1, 3, 3]
   Bias: float, [64]
   Padding: [top, left, bottom, right]=0, 0, 0, 0
   Stride: [h, w]=[1, 1]
   Activation: relu
   output: float16, [batch, H, W, outC]=[1, 30, 30, 64]
   # of MACs: 1036800
   # of Parameters: 640

Below is yet another example of a code that illustrates quantized network for illustration purposes. In this nonlimiting example, the same convolution layer as in the previous example is shown except that in this example a network is quantized to int8.
Layer 1: Conv
   Input [1]: uint8, [batch, inC, H, W]=[1, 1, 32, 32]
   Weight: int8, [outC, inC, H, W]=[64, 1, 3, 3]
   Bias: int32, [64]
   Padding: [top, left, bottom, right]=0, 0, 0, 0
   Stride: [h, w]=[1, 1]
   Activation: relu
   output: uint8, [batch, H, W, outC]=[1, 30, 30, 64]
   # of MACs: 1036800
   # of Parameters: 640

Referring back to FIG. 1, the reference system 140 may similarly include a processing unit (accelerator, CPU, etc.) and its compiler (that may be different from the compiler 120 of the target system 130) that operates on the ML model to generate tensors associated with the ML model when executed by the processing unit, e.g., ML hardware, CPU, etc. The reference system 140 may include similar components as that of the target system 130. In one nonlimiting example, the reference system 140 may include a ML hardware (may be the same as ML hardware 160 or different) may be a ML/AI inference accelerator and may be embedded with the processor of the local host. The compiler of the reference system 140 may be a compiler where the ML model has been verified on. In this nonlimiting example, the compiler of the reference system 140 may be a TVM compiler. The reference system 140 may operate on the ML model (e.g., received as pre-trained ML model) when the compiler, e.g., TVM compiler, compiles low-level instructions and generates internal representation graph, similar to compiler 120 and may further perform certain optimizations, e.g., merging/fusing, additional transformation, etc. In one nonlimiting example, the compiler for the reference system 140 determines whether to use LAMM or SAMM and whether to split input/output on tiles, split weight/bias on tiles, combination of split input/output and weight/bias and serialization on tiles, overlap primitives on tiles, for a multiplication, whether to split I/O or split weight. The low-level instructions when executed by the processor, e.g., CPU, ML hardware, ML emulator, etc., of the reference system 140 generates tensors 142, as the reference data. It is appreciated that in one nonlimiting example the binary model is generated and transmitted to the inference engine/emulator for execution. It is appreciated that the inference engine may be the ML hardware, as described above that executes the binary model or may be an emulator executed by the processor of the local host. In this nonlimiting example, the inference engine/emulator runs inference in float 16 mode or int8 quantization mode.

FIGS. 4A-4D and 6A-16D illustrate collected tensor output data for resnet50 model from Glow Interpreter, TVM interpreter, etc., and a different interpreter such as Marvell ML Compiler (MMLC) in different quantization modes and configuration for comparison purposes and illustrations. In FIGS. 4A-4D and 6A-16D, two different compilers operating on the same ML model are compared where one could be generating the reference data while the other may be the target that its performance is compared to the reference data and its operation (ML operations for ML model) is being verified.

Referring now to FIG. 4A, an example of a two-dimensional graph of relative errors for tensor data 132 versus order of magnitude is shown. In this nonlimiting example, the tensors with order of magnitude greater than the order of magnitude limit 152 (that may be user selectable) is represented as being discarded tensor elements 402. The tensors with order of magnitude less than the order of magnitude limit 152 and less than the relative error threshold 154 (that may be user selectable) may be illustrated as passed tensor elements 404 while tensors with order of magnitude less than the order of magnitude limit 152 and greater than the relative error threshold 154 may be illustrated as failed tensor elements 406. It is appreciated that for illustration purposes in this nonlimiting example, the order of magnitude limit 152 is chosen as 100 (to account up to tensors that are 100 times smaller but not more) and the relative error threshold 154 is chosen as 3%. It is appreciated that the order of magnitude limit 152 and the relative error threshold 154 may be changed by the user.

As illustrated and discussed above, tensors in ML models may contain large number of zeros or close to zero values and as such a small deviation caused by for example using a different precision or quantization between the reference system and the target system may be reflected as a large relative error, which are not reflective of an issue/problem with the compiler or the manner in which the hardware is executing the ML model. The large relative errors associated with zero or close to zero values is due to the nature in which the system is configured, e.g., precision, quantization, etc., and as such tensor values greater than the order of magnitude limit 152 may be discarded for analysis of whether the compiler and/or the underlying hardware in which the ML model is ran on is operating properly.

In this nonlimiting example, the separation between the failed tensor elements 406 and the passed tensor elements 404 is associated with improper padding of data by zeros. Padding of data with zeros is a technique often used in ML and for performing ML operations. In this nonlimiting example, the input data has improperly been padded with zeros, e.g., instead of two rows of zeros it may have been padded with three rows of zeros, causing tensors shown as failed tensor elements 406 to have relative errors that are higher than the acceptable relative error (i.e., relative error threshold 154). Accordingly, appropriate remedial actions may be taken to address the identified issues associated with improper padding.

Referring now to FIG. 4B, an example of a two-dimensional graph of relative errors for tensors 132 versus order of magnitude is shown. In this nonlimiting example, the tensors with order of magnitude greater than the order of magnitude limit 152 (that may be user selectable) is represented as being discarded tensor elements 412. The tensors with order of magnitude less than the order of magnitude limit 152 and less than the relative error threshold 154 (that may be user selectable) may be illustrated as passed tensor elements 414 while tensors with order of magnitude less than the order of magnitude limit 152 and greater than the relative error threshold 154 may be illustrated as failed tensor elements 416. It is appreciated that for illustration purposes in this nonlimiting example, the order of magnitude limit 152 is chosen as 100 (to account up to tensors that are 100 times smaller but not more) and the relative error threshold 154 is chosen as 3%. It is appreciated that the order of magnitude limit 152 and the relative error threshold 154 may be changed by the user.

In this nonlimiting example, the separation between the failed tensor elements 406 and the passed tensor elements 404 and having two parallel lines of failed tensor elements 416 is associated with improper loading of bias values due to incorrect binary generation that causes a serialization issue during execution. Accordingly, appropriate remedial actions may be taken to address the identified issues associated with improper loading of bias values due to serialization.

Referring now to FIG. 4C, an example of a two-dimensional graph of relative errors for tensors 132 versus order of magnitude is shown. In this nonlimiting example, the tensors with order of magnitude greater than the order of magnitude limit 152 (that may be user selectable) is represented as being discarded tensor elements 422. The tensors with order of magnitude less than the order of magnitude limit 152 and less than the relative error threshold 154 (that may be user selectable) may be illustrated as passed tensor elements 424 while tensors with order of magnitude less than the order of magnitude limit 152 and greater than the relative error threshold 154 may be illustrated as failed tensor elements 426. It is appreciated that for illustration purposes in this nonlimiting example, the order of magnitude limit 152 is chosen as 100 (to account up to tensors that are 100 times smaller but not more) and the relative error threshold 154 is chosen as 3%. It is appreciated that the order of magnitude limit 152 and the relative error threshold 154 may be changed by the user.

In this nonlimiting example, the investigation of the failed tensor elements 426 is identified as improper loading of coefficient values due to the compiler generated incorrected code which results in a serialization issue during execution (runtime). It is appreciated that such issues may result from instructions being executed in the wrong order or missing a necessary synchronization step, e.g., allowing execution of an instruction that manipulates data to start before previous instruction that initializes that data is complete. Accordingly, appropriate remedial actions may be taken to address the identified issues associated with improper loading of coefficient values due to serialization.

FIG. 4D illustrates an example of a two-dimensional graph of relative errors for tensors 132 versus order of magnitude is shown. In this nonlimiting example, the tensors with order of magnitude greater than the order of magnitude limit 152 (that may be user selectable) is represented as being discarded tensor elements 432. The tensors with order of magnitude less than the order of magnitude limit 152 and less than the relative error threshold 154 (that may be user selectable) may be illustrated as passed tensor elements 434 while tensors with order of magnitude less than the order of magnitude limit 152 and greater than the relative error threshold 154 may be illustrated as failed tensor elements 436. It is appreciated that for illustration purposes in this nonlimiting example, the order of magnitude limit 152 is chosen as 100 (to account up to tensors that are 100 times smaller but not more) and the relative error threshold 154 is made smaller in comparison to FIGS. 4A-4C, thereby resulting in more tensor values failing and represented as failed tensor elements 436. It is appreciated that the order of magnitude limit 152 and the relative error threshold 154 may be changed by the user.

As illustrated in FIG. 4A, a unique image is generated from comparison of generated data by a target system with incorrect padding of zeros to that of the reference system, using order of magnitude, as described above. Similarly, as illustrated in FIG. 4B, a unique image is generated from comparison of generated data by a target system with incorrect loading of bias values to that of the reference system, using order of magnitude, as described above. FIG. 4C also illustrates a unique image that is generated by comparing the generated data by the target system with improper loading of coefficient values to that of the reference system, using order of magnitude, as described above. Moreover, FIG. 4D illustrates an image that is generated by comparing the generated by the target system with no issues to that of the target system. As illustrated, the comparison (using the order of magnitude) may generate a unique image and may be classified accordingly using deep neural networks (DNN). It is appreciated that a model (e.g., ML model) may be generated for each class of error, e.g., incorrect zero padding, incorrect loading of bias values, incorrect loading of coefficient values, no error, etc. The generated models may be applied to the live data (e.g., comparison of the generated data by the target system to that of the reference system using order of magnitude) in order to classify the types of errors and/or statistical information association with each type of error. It is appreciated that the embodiments in FIGS. 5A and 5B are described with respect to creating ML models using CNN such as ResNet for illustrative purposes and should not be construed as limiting the scope of the embodiments. For example, multi-layer perceptron (MLP), transformer, long short-term memory (LSTM) based RNN networks, etc., may similarly be used to generate one or more models to classify the errors.

It is appreciated that the embodiments are described with respect to images being created for illustrative purposes and should not be construed as limiting the scope of the embodiments. For example, the embodiments are equally applicable to where the data (unique images) are represented in encoded form (e.g., multidimensional tensors) as opposed to in image form, and is provided as an input tensor to a DNN. As such, discussions with respect to images and classification of images, as described below, are for illustrative purposes and should not be construed as limiting the scope of the embodiments. For example, multidimensional tensors may be used in a DNN for classification purposes.

Referring now to FIG. 5A, a system configured to generate a ML model to classify errors using data associated with relative errors for tensors and order of magnitude according to one aspect of the present embodiments is shown. FIG. 5A is similar to that of FIG. 1, where the output 156 data is transmitted from the processor 150 to a CNN processor 560 for processing and model generation. In one nonlimiting example, a large corpus of training data may be provided to the system for training (e.g., iterative process with many epochs). In one nonlimiting example, the target system 130, the reference system 140, and the processor 150 are configured to generate a dataset, e.g., unnamed (unclassified) errors. It is appreciated that in one nonlimiting example, the processor 150 may also receive label information associated with the dataset, e.g., labels associated with unnamed (unclassified) errors. The labels may be used to classify the dataset. In this nonlimiting example, the output 156 data may be the order of magnitude versus the relative errors, as calculated, in a two-dimensional graph. For example, the output 156 data may be the image generated in FIG. 4A. In yet another example, the output 156 data may be the image generated in FIG. 4B or 4C or 4D associated with different classifications of errors and no error (as shown in FIG. 4D). The labels classify the image, i.e., error classification, associated with the output 156 data. It is appreciated that the output 156 data may be associated with any type of error classification, e.g., synchronization errors, loading wrong values (e.g., bias values, coefficient values, etc.), incorrect padding, serialization problems, clipping issues (described in greater detail below), incorrect handling of integer quantization format type, scaling issues that causes overflow/underflow issues, incorrect memory mapping (e.g., transmission of wrong data from on-chip memory (OCM) to a double data rate (DDR)), data access, memory allocation, lower-level instruction calls, orientation (dimension reordering), splitting or copying errors, etc. It is appreciated that the errors are described with respect to compiler errors for illustrative purposes only and should not be construed as limiting the scope of the embodiments. For example, the error may be associated with a hardware failure.

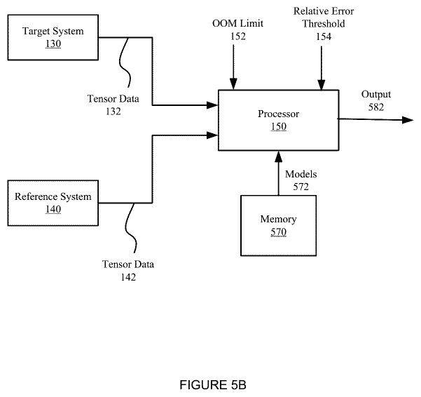

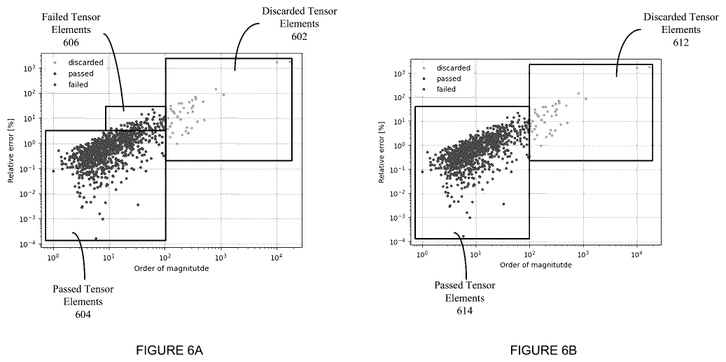

In one nonlimiting example, the output 156 data may be training data (supervised learning) used in generating the model but in some embodiments it may be unsupervised. The output 156 data in one nonlimiting example is a large set of labeled training data containing many labeled images (e.g., classified errors). For illustration purposes, the embodiments are described with respect to the output 156 data being supervised. The output 156 data may be the generated data as shown in FIGS. 6A-18B. In other words, the output 156 data may be one or more images generated by generating a relative errors (by comparing tensor values of the target system to the tensor values of the reference system) for the tensor values of the target system represented in order of magnitude, as described in FIGS. 1-4D and below in FIGS. 6A-18B. It is appreciated that the embodiments are described with respect to the output 156 data being an image for illustrative purposes only and should not be construed as limiting the scope of the embodiments. For example, the output 156 data may be a representation of data stored as a multi-dimensional tensor, e.g., provided in NCHW format (batch size, channel, height, width) or NHWC (batch size, height, width, channel). According to one nonlimiting example, a channel dimension may be 3 to match RGB colors of an image. In yet one nonlimiting example, brightness of a pixel may be also used.

The CNN processor 560 is configured to receive the output 156 data at its input. The CNN processor 560 receives a large dataset of training images associated with known classification, e.g., improper loading of bias values, improper loading of coefficient values, improper zero padding, improper memory mapping, clipping issues, scaling issues, etc., as described above. In one nonlimiting example, the output 156 data may also include a large dataset associated with images with no errors (errors under a given threshold). It is appreciated that the CNN processor 560 may run on one or more processors where it receives the training data set and the model design as its input and generates a trained model 562. The CNN processor 560 may perform feature extraction on the received dataset, i.e., output 156 data. Feature extraction may input receiving an input data (a portion of an image), performing a convolution on the input data, and performing a pooling operation. The CNN processor 560 may also perform classification on the result of the feature extraction to generate an output. The output may include a plurality of parameters. In one example, a parameter may indicate the data matched and may provide statistical information associated therewith, e.g., percentage of data match (below a certain error threshold (OOM versus relative error threshold), percentage of data with improper zero padding, percentage of data with improper loading of bias values, etc. It is appreciated that the parameters may be normalized probability for each error classification. The CNN processor 560 generates a model 562 associated with each dataset (i.e., error classification). In other words, the CNN processor 560 generates a plurality of ML models that are stored in the memory 570. It is appreciated that the CNN processor 560 is shown as being separate from the processor 150 for illustrative purposes only and should not be construed as limiting the scope of the embodiments. For example, the CNN model may be executed and implemented by the processor 150.

Referring now to FIG. 5B, the system for classifying errors based on the generated models of FIG. 5A according to one aspect of the present embodiments is shown. In one nonlimiting example, the models 572 (e.g., ML models) stored in the memory 570 may be sent to the processor 150. The processor 150 may generate an image (similar to FIGS. 4A-4B or FIGS. 6A-18B shown below) associated with comparison of data generated by a target system to that of a reference system, using OOM. The models 572 generated may be applied to the generated image by the processor 150 to classify one or more errors associated with the comparison. In one nonlimiting example, the error classification may include one or more of synchronization errors, loading wrong values (e.g., bias values, coefficient values, etc.), incorrect padding, serialization problems, clipping issues (described in greater detail below), incorrect handling of integer quantization format type, scaling issues that causes overflow/underflow issues, incorrect memory mapping (e.g., transmission of wrong data from on-chip memory (OCM) to a double data rate (DDR)), data access, memory allocation, lower-level instruction calls, orientation (dimension reordering), splitting or copying errors, hardware failures, etc. In one nonlimiting example, classification may be accompanied with additional data, e.g., statistical information associated with each error classification such as percentage of errors within each error classification. The processor 150 outputs 582 the result of the error classification and/or accompanying data.

Referring now to FIG. 6A, comparison of reference tensors generated by for example Glow Interpreter FP32 with a proprietary TVM FP16 is shown for illustration purposes. For illustration purposes the order of magnitude limit 152 is selected as 100 and the relative error threshold 154 of 3% is selected. As illustrated the tensor values greater than the order of magnitude limit 152 are represented (rendered) as discarded tensor elements 602 while tensor values with order of magnitude of less than the order of magnitude limit 152 and with relative error of less than or equal to the relative error threshold 154 are represented (rendered) as passed tensor elements 604. In contrast, the tensor values with order of magnitude less than the order of magnitude limit 152 and with relative error of greater than or equal to the relative error threshold 154 are represented (rendered) as failed tensor elements 606. In this nonlimiting example, the maximum absolute different is 0.054200, which may be the maximum absolute difference between two tensor elements. It is appreciated that the maximum absolute different may be divided by the reference value, resulting in a percentage value. Referring now to FIG. 6B, the relative error threshold 154 is changed from 3% to 22% for illustration purposes for comparing performance of Glow Interpreter FP32 with the proprietary TVM FP16. As illustrated increasing the relative error threshold 154 results in more tensor values (in this case all) passing the threshold with respect to FIG. 6A and indicated as passed tensor elements 614 while the same tensor values that exceed the order of magnitude limit 152 are represented as discarded tensor elements 612 (which is the same as discarded tensor elements 602).

It is appreciated that throughout this application, identifying tensor values as discarded are described by comparing their order of magnitude to that of the order of magnitude limit 152 and whether they exceed the limit or not for illustration purposes. However, it is appreciated that the embodiments are not limited thereto. For example, in some examples, the tensor values that have order of magnitude of greater than or equal to the limit may be identified as discarded tensor elements. Moreover, it is appreciated that throughout this application, identifying tensor values as passed or failed are described by comparing their order of magnitude to that of the order of magnitude limit 152 and whether their respective relative error for order of magnitude that are less than the limit have a relative error that is less than the threshold relative error for illustration purposes. However, it is appreciated that the embodiments are not limited thereto. For example, in some examples, the tensor values that have order of magnitude of less than or equal to the limit and a relative error of less than or equal to the threshold relative error may be identified as passed tensor elements and others as failed tensor elements.

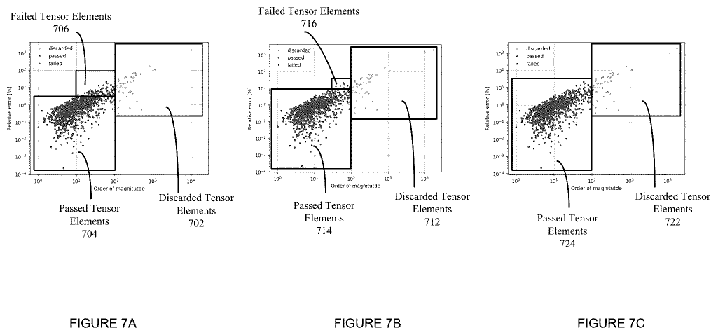

Referring now to FIG. 7A, comparison of reference tensors generated by for example Glow Interpreter FP32 with a proprietary TVM FP32 is shown for illustration purposes. For illustration purposes the order of magnitude limit 152 is selected as 100 and the relative error threshold 154 of 3% is selected. As illustrated the tensor values greater than the order of magnitude limit 152 are represented (rendered) as discarded tensor elements 702 while tensor values with order of magnitude of less than the order of magnitude limit 152 and with relative error of less than or equal to the relative error threshold 154 are represented (rendered) as passed tensor elements 704. In contrast, the tensor values with order of magnitude less than the order of magnitude limit 152 and with relative error of greater than or equal to the relative error threshold 154 are represented (rendered) as failed tensor elements 706. In this nonlimiting example, the maximum absolute different is 0.047721. Referring now to FIG. 7B, the relative error threshold 154 is changed from 3% to 10% for illustration purposes for comparing performance of Glow Interpreter FP32 with the proprietary TVM FP32. As illustrated increasing the relative error threshold 154 results in more tensor values passing the threshold and indicated as passed tensor elements 714 and reducing the number of failed tensor elements 716 with respect to FIG. 7A. It is appreciated that the same tensor values that exceed the order of magnitude limit 152, as in FIG. 7A, are represented as discarded tensor elements 712 (which is the same as discarded tensor elements 702) because the order of magnitude limit 152 remains unchanged. Referring now to FIG. 7C, the relative error threshold 154 is changed from 10% to 22% for illustration purposes for comparing performance of Glow Interpreter FP32 with the proprietary TVM FP32. As illustrated increasing the relative error threshold 154 results in more tensor values passing the threshold (in this case all tensor values are passed) and indicated as passed tensor elements 724 and reducing the number of failed tensor elements to zero with respect to FIGS. 7A and 7B. It is appreciated that the same tensor values that exceed the order of magnitude limit 152, as in FIGS. 7A and 7B, are represented as discarded tensor elements 722 (which is the same as discarded tensor elements 702) because the order of magnitude limit 152 remains unchanged.

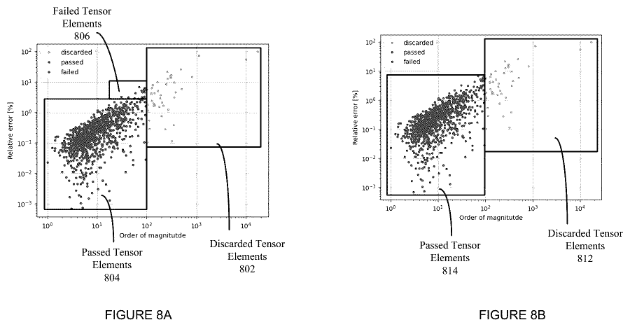

Referring now to FIG. 8A, comparison of reference tensors generated by for example Glow Interpreter FP32 with Glow Interpreter FP16 is shown for illustration purposes. For illustration purposes the order of magnitude limit 152 is selected as 100 and the relative error threshold 154 of 3% is selected. As illustrated the tensor values greater than the order of magnitude limit 152 are represented (rendered) as discarded tensor elements 802 while tensor values with order of magnitude of less than the order of magnitude limit 152 and with relative error of less than or equal to the relative error threshold 154 are represented (rendered) as passed tensor elements 804. In contrast, the tensor values with order of magnitude less than the order of magnitude limit 152 and with relative error of greater than or equal to the relative error threshold 154 are represented (rendered) as failed tensor elements 806. In this nonlimiting example, the maximum absolute different is 0.015220. Referring now to FIG. 8B, the relative error threshold 154 is changed from 3% to 7% for illustration purposes for comparing performance of Glow Interpreter FP32 with the Glow Interpreter FP16. As illustrated increasing the relative error threshold 154 results in more tensor values (in this case all) passing the threshold with respect to FIG. 8A and indicated as passed tensor elements 814 while the same tensor values that exceed the order of magnitude limit 152 are represented as discarded tensor elements 812 (which is the same as discarded tensor elements 802).

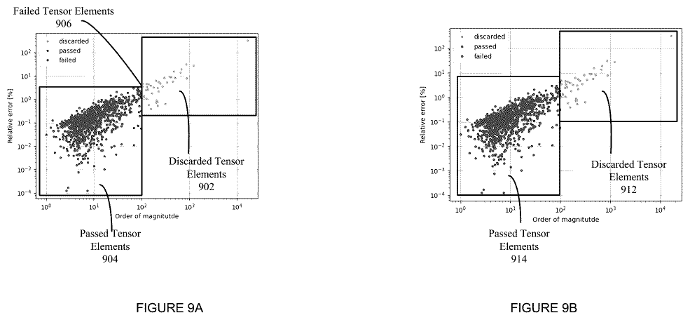

Referring now to FIG. 9A, comparison of reference tensors generated by for example TVM Interpreter FP32 with a proprietary TVM FP16 is shown for illustration purposes. For illustration purposes the order of magnitude limit 152 is selected as 100 and the relative error threshold 154 of 3% is selected. As illustrated the tensor values greater than the order of magnitude limit 152 are represented (rendered) as discarded tensor elements 902 while tensor values with order of magnitude of less than the order of magnitude limit 152 and with relative error of less than or equal to the relative error threshold 154 are represented (rendered) as passed tensor elements 904. In contrast, the tensor values with order of magnitude less than the order of magnitude limit 152 and with relative error of greater than or equal to the relative error threshold 154 are represented (rendered) as failed tensor elements 906. In this nonlimiting example, the maximum absolute different is 0.012347. Referring now to FIG. 9B, the relative error threshold 154 is changed from 3% to 5% for illustration purposes for comparing performance of TVM Interpreter FP32 with the proprietary TVM Interpreter FP16. As illustrated increasing the relative error threshold 154 results in more tensor values (in this case all) passing the threshold with respect to FIG. 9A and indicated as passed tensor elements 914 while the same tensor values that exceed the order of magnitude limit 152 are represented as discarded tensor elements 912 (which is the same as discarded tensor elements 902).

Referring now to FIG. 10A, comparison of reference tensors generated by for example Glow Interpreter FP32 with TVM FP32 is shown for illustration purposes. For illustration purposes the order of magnitude limit 152 is selected as 100 and the relative error threshold 154 of 3% is selected. As illustrated the tensor values greater than the order of magnitude limit 152 are represented (rendered) as discarded tensor elements 1002 while tensor values with order of magnitude of less than the order of magnitude limit 152 and with relative error of less than or equal to the relative error threshold 154 are represented (rendered) as passed tensor elements 1004. In contrast, the tensor values with order of magnitude less than the order of magnitude limit 152 and with relative error of greater than or equal to the relative error threshold 154 are represented (rendered) as failed tensor elements 1006. In this nonlimiting example, the maximum absolute different is 0.047721.

Referring now to FIG. 10B, comparison of reference tensors generated by for example Glow Interpreter FP32 with a proprietary TVM FP16 is shown for illustration purposes. For illustration purposes the order of magnitude limit 152 is selected as 100 and the relative error threshold 154 of 3% is selected. As illustrated the tensor values greater than the order of magnitude limit 152 are represented (rendered) as discarded tensor elements 1012 while tensor values with order of magnitude of less than the order of magnitude limit 152 and with relative error of less than or equal to the relative error threshold 154 are represented (rendered) as passed tensor elements 1014. In contrast, the tensor values with order of magnitude less than the order of magnitude limit 152 and with relative error of greater than or equal to the relative error threshold 154 are represented (rendered) as failed tensor elements 1016. In this nonlimiting example, the maximum absolute different is 0.054200.

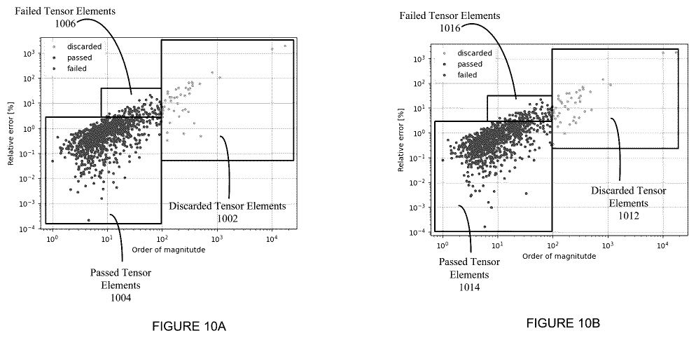

Referring now to FIG. 11A, comparison of reference tensors generated by for example Glow Interpreter FP16 with a proprietary TVM FP16 is shown for illustration purposes. For illustration purposes the order of magnitude limit 152 is selected as 100 and the relative error threshold 154 of 3% is selected. As illustrated the tensor values greater than the order of magnitude limit 152 are represented (rendered) as discarded tensor elements 1102 while tensor values with order of magnitude of less than the order of magnitude limit 152 and with relative error of less than or equal to the relative error threshold 154 are represented (rendered) as passed tensor elements 1104. In contrast, the tensor values with order of magnitude less than the order of magnitude limit 152 and with relative error of greater than or equal to the relative error threshold 154 are represented (rendered) as failed tensor elements 1106. In this nonlimiting example, the maximum absolute different is 0.051270. Referring now to FIG. 11B, the relative error threshold 154 is changed from 3% to 25% for illustration purposes for comparing performance of Glow Interpreter FP16 with the proprietary TVM Interpreter FP16. As illustrated increasing the relative error threshold 154 results in more tensor values (in this case all) passing the threshold with respect to FIG. 11A and indicated as passed tensor elements 1114 while the same tensor values that exceed the order of magnitude limit 152 are represented as discarded tensor elements 1112 (which is the same as discarded tensor elements 1102).

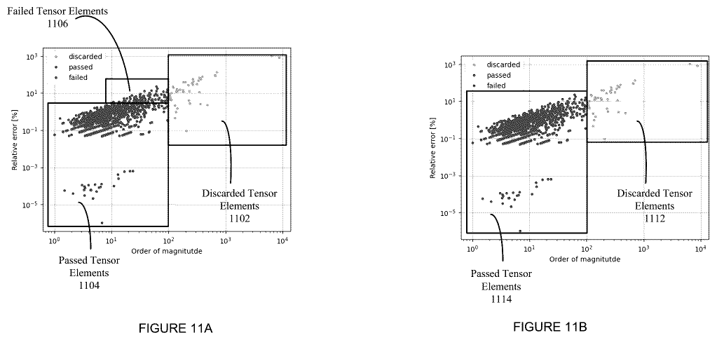

Referring now to FIG. 12A, comparison of reference tensors generated by for example Glow Interpreter FP32 with Glow Interpreter int8 is shown for illustration purposes. For illustration purposes the order of magnitude limit 152 is selected as 100 and the relative error threshold 154 of 3% is selected. As illustrated, the tensor values greater than the order of magnitude limit 152 are represented (rendered) as discarded tensor elements 1202 while tensor values with order of magnitude of less than the order of magnitude limit 152 and with relative error of less than or equal to the relative error threshold 154 are represented (rendered) as passed tensor elements 1204. In contrast, the tensor values with order of magnitude less than the order of magnitude limit 152 and with relative error of greater than or equal to the relative error threshold 154 are represented (rendered) as failed tensor elements 1206. In this nonlimiting example, the maximum absolute different is 1.498690. Referring now to FIG. 12B, the relative error threshold 154 is changed from 3% to 50% for illustration purposes for comparing performance of Glow Interpreter FP32 with the Glow Interpreter int8. As illustrated increasing the relative error threshold 154 results in more tensor values passing the threshold with respect to FIG. 12A and indicated as passed tensor elements 1214 and fewer tensor values failing with respect to FIG. 12A and indicated as failed tensor elements 1216 while the same tensor values that exceed the order of magnitude limit 152 are represented as discarded tensor elements 1212 (which is the same as discarded tensor elements 1202). Referring now to FIG. 12C, the relative error threshold 154 is changed to 330% for illustration purposes for comparing performance of Glow Interpreter FP32 with the Glow Interpreter int8. As illustrated increasing the relative error threshold 154 results in more tensor values passing the threshold with respect to FIG. 12A and indicated as passed tensor elements 1224 and no tensor values failing with respect to FIG. 12A while the same tensor values that exceed the order of magnitude limit 152 are represented as discarded tensor elements 1222 (which is the same as discarded tensor elements 1202).

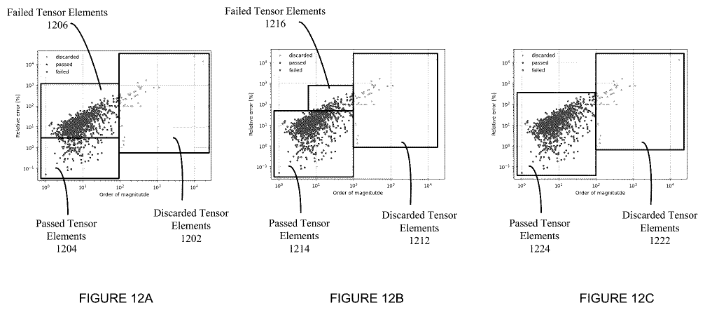

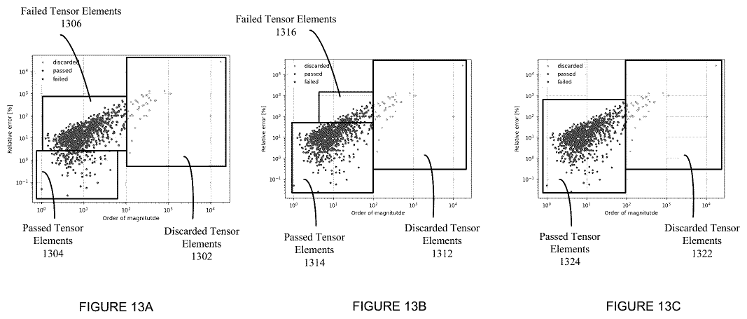

Referring now to FIG. 13A, comparison of reference tensors generated by for example Glow Interpreter FP32 with proprietary TVM int8 is shown for illustration purposes. For illustration purposes the order of magnitude limit 152 is selected as 100 and the relative error threshold 154 of 3% is selected. As illustrated, the tensor values greater than the order of magnitude limit 152 are represented (rendered) as discarded tensor elements 1302 while tensor values with order of magnitude of less than the order of magnitude limit 152 and with relative error of less than or equal to the relative error threshold 154 are represented (rendered) as passed tensor elements 1304. In contrast, the tensor values with order of magnitude less than the order of magnitude limit 152 and with relative error of greater than or equal to the relative error threshold 154 are represented (rendered) as failed tensor elements 1306. In this nonlimiting example, the maximum absolute different is 1.441597. Referring now to FIG. 13B, the relative error threshold 154 is changed from 3% to 50% for illustration purposes for comparing performance of Glow Interpreter FP32 with the proprietary TVM int8. As illustrated increasing the relative error threshold 154 results in more tensor values passing the threshold with respect to FIG. 13A and indicated as passed tensor elements 1314 and fewer tensor values failing with respect to FIG. 13A and indicated as failed tensor elements 1316 while the same tensor values that exceed the order of magnitude limit 152 are represented as discarded tensor elements 1312 (which is the same as discarded tensor elements 1302). Referring now to FIG. 13C, the relative error threshold 154 is changed to 480% for illustration purposes for comparing performance of Glow Interpreter FP32 with the proprietary TVM int8. As illustrated increasing the relative error threshold 154 results in more tensor values passing the threshold with respect to FIG. 13A and indicated as passed tensor elements 1324 and no tensor values failing with respect to FIG. 13A while the same tensor values that exceed the order of magnitude limit 152 are represented as discarded tensor elements 1322 (which is the same as discarded tensor elements 1302).

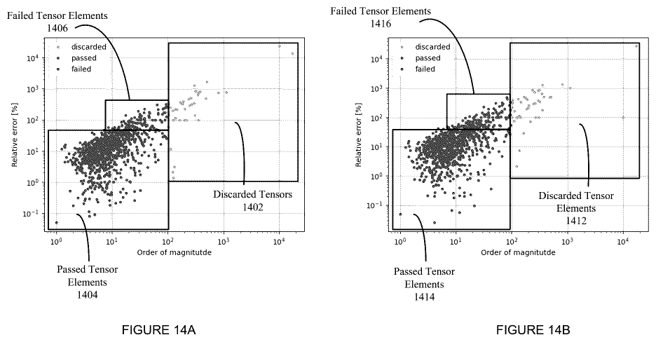

FIGS. 14A and 14B illustrate comparison of two different INT8 resulting from two different compilers (e.g., Glow and TVM) with a Glow Interpreter FP32. Referring now to FIG. 14A, comparison of reference tensors generated by for example Glow Interpreter FP32 with Glow Interpreter int8 is shown for illustration purposes. For illustration purposes the order of magnitude limit 152 is selected as 100 and the relative error threshold 154 of 50% is selected. As illustrated the tensor values greater than the order of magnitude limit 152 are represented (rendered) as discarded tensor elements 1402 while tensor values with order of magnitude of less than the order of magnitude limit 152 and with relative error of less than or equal to the relative error threshold 154 are represented (rendered) as passed tensor elements 1404. In contrast, the tensor values with order of magnitude less than the order of magnitude limit 152 and with relative error of greater than or equal to the relative error threshold 154 are represented (rendered) as failed tensor elements 1406. In this nonlimiting example, the maximum absolute different is 1.498690. Referring now to FIG. 14B, INT8 resulting from TVM is being compared to Glow interpreter FP32 that results in a different maximum absolute different value. It this example, the relative error threshold 154 is maintained while the maximum absolute difference is now 1.441597. The discarded tensor elements 1412 is the same as that of FIG. 14A. The failed tensor elements 1416 and the passed tensor elements 1414 may also be rendered and identified, as illustrated.

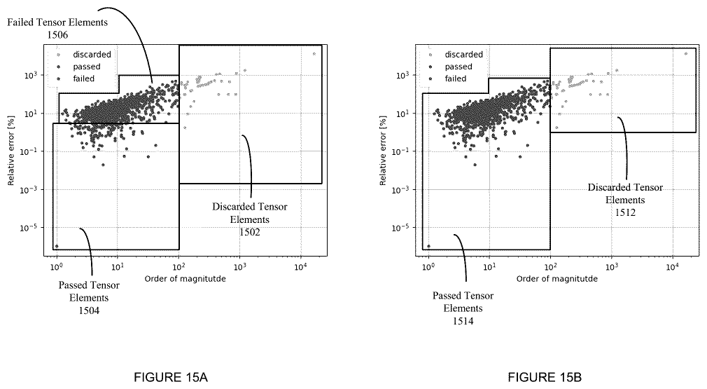

Referring now to FIG. 15A, comparison of reference tensors generated by for example TVM Interpreter FP32 with a proprietary TVM int8 is shown for illustration purposes. For illustration purposes the order of magnitude limit 152 is selected as 100 and the relative error threshold 154 of 3% is selected. As illustrated the tensor values greater than the order of magnitude limit 152 are represented (rendered) as discarded tensor elements 1502 while tensor values with order of magnitude of less than the order of magnitude limit 152 and with relative error of less than or equal to the relative error threshold 154 are represented (rendered) as passed tensor elements 1504. In contrast, the tensor values with order of magnitude less than the order of magnitude limit 152 and with relative error of greater than or equal to the relative error threshold 154 are represented (rendered) as failed tensor elements 1506. In this nonlimiting example, the maximum absolute difference is 1.431841. Referring now to FIG. 15B, the relative error threshold 154 is changed to 462% with the same maximum absolute difference of 1.431841 maintained. The discarded tensor elements 1512 is the same as that of FIG. 15A. As illustrated increasing the relative error threshold 154 results in more tensor values as being indicated as passed tensor elements 1514 and in this example no failure is identified, as illustrated.

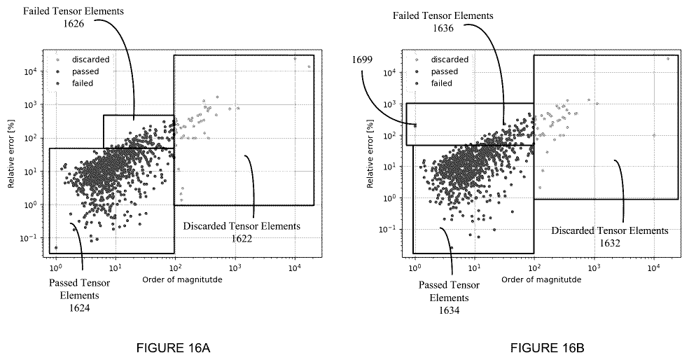

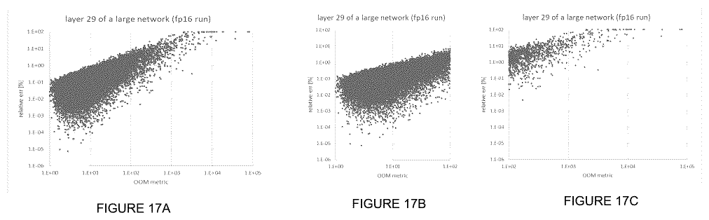

Referring now to FIGS. 16A and 16B, wherein the impact of performing clipping of last layer is investigated (as needed while moving data to double data rate (DDR) memory) in comparison to not clipping the last layer. In this nonlimiting example, the OCM for is 9-bits whereas the DDR may be 8-bits. As such, without proper clipping, the lower 8-bits of the 9-bit for the OCM may be interpreted incorrectly when being transmitted to the DDR. As one nonlimiting example, for int9 the sign bit is the 9th bit while for int8 the sign bit is the 8th bit and without clipping in int9 the lower 8 bits are sent from the OCM to the DDR and the 8th bit is interpreted as the sign bit, e.g., negative number in Int9 such as 101111100 becomes 011111100 and as int8 number would be interpreted as a positive number. As shown in FIG. 16A, the clipping in the last layer results in discarded tensor elements 1622, the passed tensor elements 1624, and the failed tensor elements 1626 may be rendered. In FIG. 16A the maximum absolute difference is 1.498690. In comparison, in FIG. 16B, failing to perform clipping of last layer results in a failure 1699 which is a single value which overflows from int8 to int9 in OCM. In FIG. 16B the maximum absolute difference is 26.544254. In FIG. 16B, the discarded tensor elements 1632, the passed tensor elements 1634, and the failed tensor elements 1636 may be rendered.

The comparison of different compilers, as shown above, may reveal that the output values may be front-end dependent. In yet one example, it may be determined that the relative error rates may be due to the ordering of the operations, e.g., between Glow Interpreter versus the TVM due to the ordering of left and right branches. Yet in one nonlimiting example, one may observe a similar correlation between the compilers. In yet another example, the comparison and investigation of the passed tensor elements and failed tensor elements may reveal that int8 quantization does show significant differences in terms of absolute different and relative percentage difference. Moreover, one may conclude that clipping (to int8) does have noticeable effect on the output results when clipping is not done internally. In yet another example, one may conclude a major difference when clipping is not done when data is being moved from OCM to DDR (due to sign flipping). Accordingly, one may take remedial action to ensure that the compiler clips data when the data is being moved from OCM to DDR.

Referring now to FIGS. 17A-17C, wherein relative errors for output of tensor data associated with layer 29 of a large network in FP16 in comparison to reference system FP32 and its order of magnitude is shown in accordance with some embodiments. In this example, a number of tensors is 34556 elements in a complex production ML network. In one nonlimiting example, the tensor may be an intermediate result in one of many layers of a large network, e.g., layer 29. As illustrated FIG. 17A depicts all tensors of layer 29 in an order of magnitude, as described above. FIG. 17B depicts all tensors of layer 29 that are smaller than the order of magnitude limit 152, e.g., 100, while FIG. 17C depicts all tensors of layer 29 that are greater than the order of magnitude limit 152. As illustrated, there are many tensors with values close to zero which are shown in FIG. 17C, which may be discarded as described above.

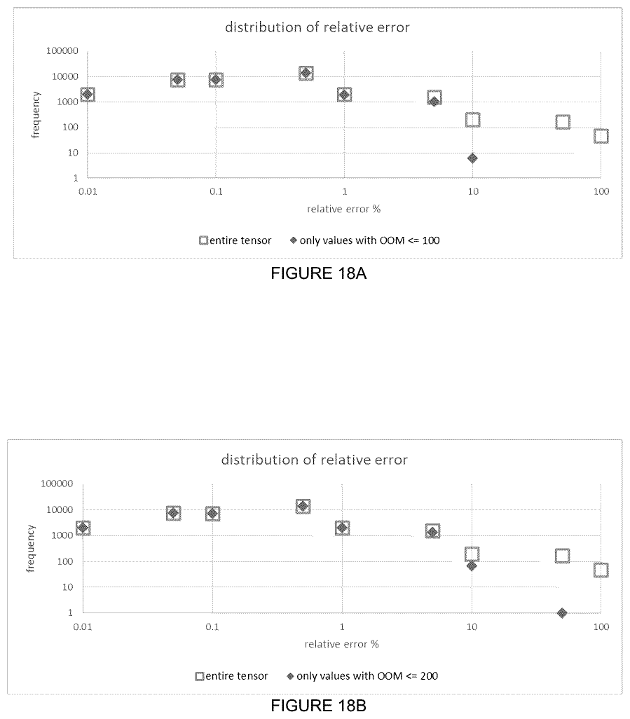

For illustration purposes, referring now to FIGS. 18A-18B wherein relative error distribution for different order of magnitude limits are shown for output of tensor data associated with layer 29 of a large network in FP16 in comparison to reference system FP32 and its order of magnitude is shown in accordance with some embodiments. In this example, a number of tensors is 34556 elements in a complex production ML network. In one nonlimiting example, the tensor may be an intermediate result in one of many layers of a large network, e.g., layer 29. In FIG. 18A, the order of magnitude limit of 100 is used whereas in FIG. 18B the order of magnitude limit of 200 is used. As illustrated, as the order of magnitude increases and removed the number of relative errors increases. For illustration purposes the table below shows the tensor data and frequency of their relative errors within the order of magnitude. The table below illustrates the relative errors divided into 9 groups (buckets) for illustrative purposes, the first group errors between 0-0.01, the second group errors between 0.01-0.05, the third group errors between 0.05-0.1, the fourth group errors between 0.1-0.5, the fifth group errors between 0.5-1, the sixth group errors between 1-5, the seventh group errors between 5-10, the eight group errors between 10-50, and the ninth group errors between 50-100. The number of tensor elements (frequency) associated with each group is also illustrated as well as the OOM for each group for illustrative purposes.

| buckets | freq all | freq OOM 0 to 100 |
|---|---|---|
| 0.01 | 1966 | 1965 |
| 0.05 | 7520 | 7507 |
| 0.1 | 7228 | 7218 |
| 0.5 | 13851 | 13744 |
| 1 | 2014 | 1893 |
| 5 | 1571 | 1019 |
| 10 | 197 | 6 |
| 50 | 163 | 0 |
| 100 | 46 | 0 |
| | 34556 | 33352 |

For illustration purposes it can be seen that for the bucket covering the relative errors of 5-10% (0.05-0.1), the frequency of entries is 197 entries but applying the OOM limit there are only 6 elements for that relative error. As illustrated, the OOM application removes the complexity of investigating approximately 200 entries to investigating only 6 as a starting point. Additionally, without leveraging OOM one may be required to investigate 46 elements plus 163 elements that have a greater than 10% relative error first before even investigating the 196 elements associated with relative errors of 5%-10%.

As illustrated, the distribution graph without order of magnitude contains additional information that is absent from distribution graphs of full tensors when only their relative errors are being displayed. As such, utilizing order of magnitude enables investigation of problems/issues with a given compiler to be expedited because tensor data with order of magnitude greater than the limit are discarded since they are close to zero and smallest deviations, e.g., precision, quantization, etc., may result in large relative errors.

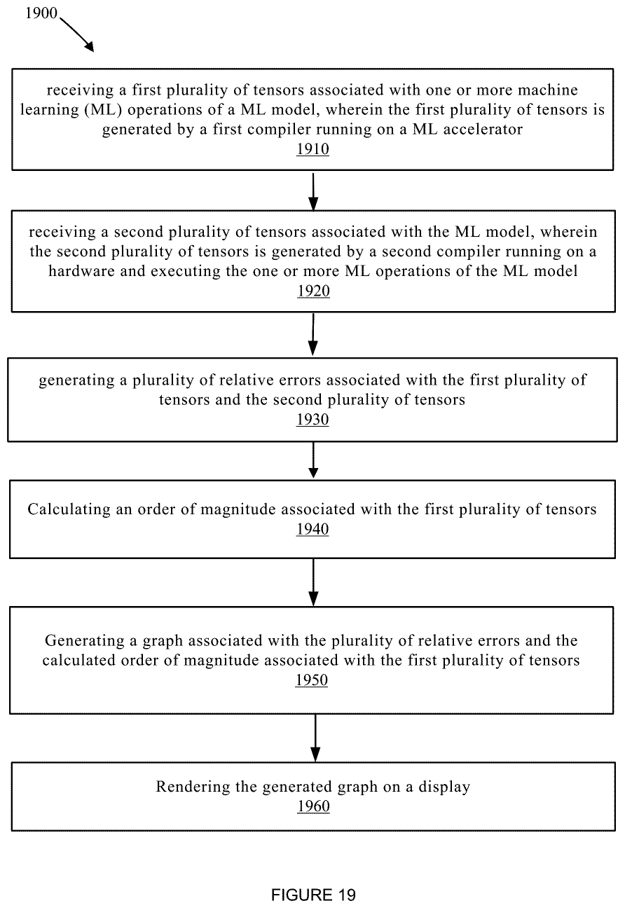

FIG. 19 depicts a flowchart 1900 for processing tensor values and generating order of magnitude associated with relative errors of the tensor values according to one aspect of the present embodiments. Although the figure depicts functional steps in a particular order for purposes of illustration, the processes are not limited to any particular order or arrangement of steps. One skilled in the relevant art will appreciate that the various steps portrayed in this figure could be omitted, rearranged, combined and/or adapted in various ways. At step 1910, a first plurality of tensors associated with one or more machine learning (ML) operations of a ML model is received (e.g., target system generating the first plurality of tensors). The first plurality of tensors (each tensor with a plurality of tensor elements) is generated by a first compiler running on a ML accelerator. At step 1920, a second plurality of tensors (each tensor with another plurality of tensor elements) associated with the ML model is received (e.g., reference system generating the second plurality of tensors). The second plurality of tensors is generated by a second compiler running on a hardware and executing the one or more ML operations of the ML model. At step 1930, a plurality of relative errors associated with the first plurality of tensors and the second plurality of tensors are generated. At step 1940, an order of magnitude associated with the first plurality of tensors is calculated. At step 1950, a graph associated with the plurality of relative errors and the calculated order of magnitude associated with the first plurality of tensors is generated and rendered at step 1960 on a display.

It is appreciated that in some embodiments, the method also includes receiving an order of magnitude limit. Thus, a first subset of tensors from the first plurality of tensors with order of magnitude greater than the order of magnitude limit may be represented as discarded. In some embodiments, the method further includes receiving a relative error threshold value. As such, a second subset of tensors from the first plurality of tensors with relative errors greater than the relative error threshold value may be represented as failed. The second subset of tensors and the first subset of tensors are mutually exclusive.

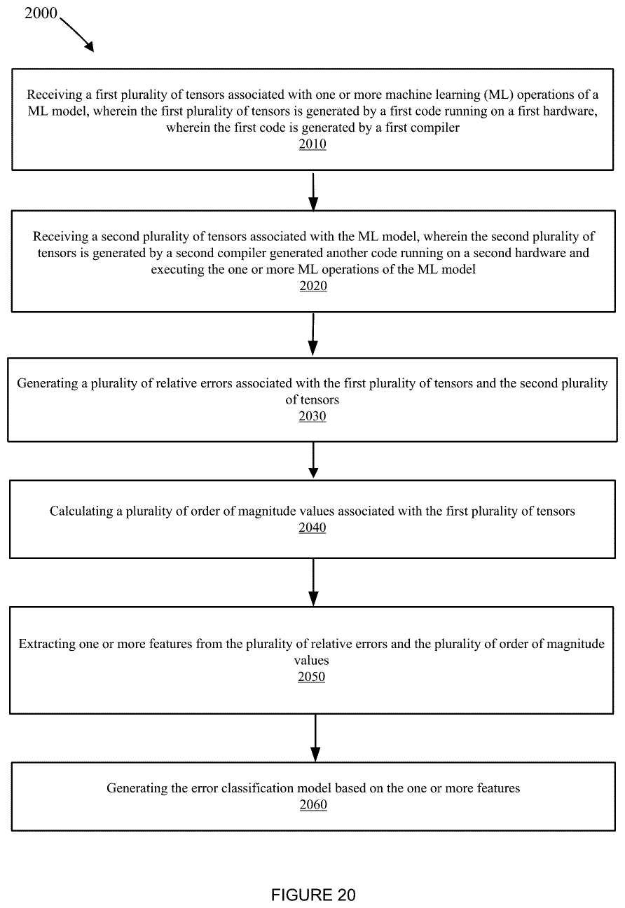

Referring now to FIG. 20, a flowchart 2000 of an example of generating a model to classify errors associated with a ML operation using data associated with relative errors for tensors and order of magnitude according to one aspect of the present embodiments is shown. At step 2010, a first plurality of tensors associated with one or more machine learning (ML) operations of a ML model is received, as described above. The first plurality of tensors is generated by a first code running on a first hardware, e.g., ML accelerator. It is appreciated that the first code is generated by a first compiler, as described above and each tensor of the first plurality of tensors comprises a plurality of tensor elements. At step 2020, a second plurality of tensors associated with the ML model is received, as described above. The second plurality of tensors is generated by a second compiler generated another code running on a second hardware and executing the one or more ML operations of the ML model, as discussed above. It is appreciated that each tensor of the second plurality of tensors comprises another plurality of tensor elements. At step 2030, a plurality of relative errors associated with the first plurality of tensors and the second plurality of tensors is generated, as described above. At step 2040, a plurality of order of magnitude values associated with the first plurality of tensors is calculated, as described in FIGS. 1-19. At step 2050, one or more features from the plurality of relative errors and the plurality of order of magnitude values are extracted, as described in FIGS. 5A-5B. At step 2060, the error classification model, e.g., ML model based on CNN, transformer, LSTM, etc., is generated based on the one or more features, as described in FIGS. 5A-5B. It is appreciated that for supervised training, the labels associated with the error classification may be provided after step 2050 but before the step 2060.

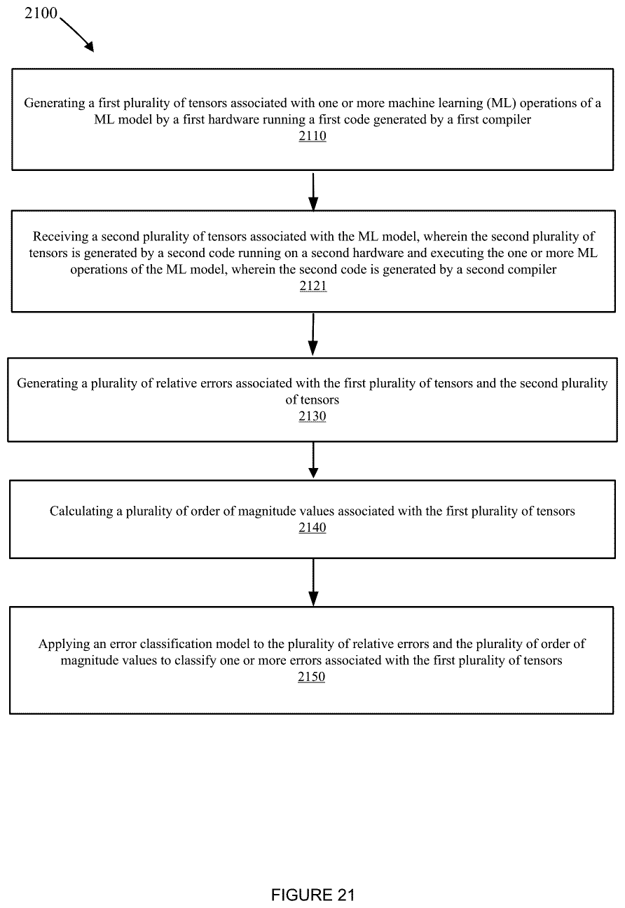

Referring now to FIG. 21, a flowchart 2100 of an example of applying a generated model to classify errors associated with a ML operation using data associated with relative errors for tensors and order of magnitude according to one aspect of the present embodiments is shown. At step 2110, a first plurality of tensors associated with one or more machine learning (ML) operations of a ML model is generated by a first hardware running a first code generated by a first compiler, as described in FIGS. 1-19. It is appreciated that in one nonlimiting example, each tensor of the first plurality of tensors comprises a plurality of tensor elements. At step 2120, a second plurality of tensors associated with the ML model is received, as described above in FIGS. 1-19. The second plurality of tensors is generated by a second code being ran on a second hardware and executing the one or more ML operations of the ML model, as described above. It is appreciated that the second code is generated by a second compiler and each tensor of the second plurality of tensors comprises another plurality of tensor elements. At step 2130, a plurality of relative errors associated with the first plurality of tensors and the second plurality of tensors is generated, as described above in FIGS. 1-19. At step 2140, a plurality of order of magnitude values associated with the first plurality of tensors is calculated, as described above in FIGS. 1-19. At step 2150, an error classification model is applied to the plurality of relative errors and the plurality of order of magnitude values to classify one or more errors associated with the first plurality of tensors, as described in FIGS. 5A-5B.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system, comprising:
a first hardware running a first code generated by a first compiler, wherein the first compiler running on the first hardware is configured to generate a first plurality of tensors associated with one or more machine learning (ML) operations of a ML model during generation of an error classification model; and
a processor configured to
receive the first plurality of tensors associated with the ML model;
receive a second plurality of tensors associated with the ML model, wherein the second plurality of tensors is generated a second code running on a second hardware and executing the one or more ML operations of the ML model, wherein the second code is generated by a second compiler;
generate a plurality of relative errors associated with the first plurality of tensors and the second plurality of tensors;
calculate a plurality of order of magnitude values associated with the first plurality of tensors;
extract one or more features from the plurality of relative errors and the plurality of order of magnitude values; and
generate the error classification model based on the one or more features.

2. The system of claim 1, wherein the processor is further configured to generate an image associated with the plurality of relative errors and the calculated order of magnitude associated with the first plurality of tensors, and wherein the one or more features is extracted from the image.

3. The system of claim 1, wherein the processor is configured to implement a convolutional neural network (CNN) for extracting the one or more features and further for generating the error classification model.

4. The system of claim 3, wherein the CNN is a ResNet model.

5. The system of claim 1, wherein the processor is configured to implement a multi-layer perceptron (MLP) for extracting the one or more features and further for generating the error classification model.

6. The system of claim 1, wherein the processor is configured to implement a transformer or a long short-term memory (LSTM) for extracting the one or more features and further for generating the error classification model.

7. The system of claim 1, wherein the first hardware is a ML accelerator.

8. The system of claim 1, wherein the error classification includes at least one or more of a synchronization error, an improper loading value error, incorrect zero padding error, serialization error, clipping error, incorrect handling of integer quantization format type error, scaling error, incorrect memory mapping error, data access error, memory allocation error, lower-level instruction calls error, orientation error, or splitting or copying error.

9. The system of claim 1, wherein the error classification includes at least one or more of incorrect compilation, incorrect data loading, or a hardware failure.

10. The system of claim 1, wherein the first plurality of tensors is in a channel, height weight format.

11. The system of claim 10, wherein the channel includes red, green, and blue.

12. The system of claim 10, wherein the channel is greater than three.

13. The system of claim 1, wherein the error classification includes a normalized probability associated with each error classification.

14. The system of claim 1, wherein the processor is configured to receive an order of magnitude limit, and wherein a first subset of tensors from the first plurality of tensors with order of magnitude greater than the order of magnitude limit is represented as discarded, wherein the processor is configured to receive a relative error threshold value, wherein a second subset of tensors from the first plurality of tensors with relative errors greater than the relative error threshold value is represented as failed, and wherein the second subset of tensors and the first subset of tensors are mutually exclusive, wherein the processor is configured to represent a third subset of tensors from the first plurality of tensors as passed, wherein the third subset of tensors, the second subset of tensors, and the first subset of tensors are mutually exclusive from one another.

15. The system of claim 14, wherein the relative error threshold value is user selectable.

16. The system of claim 14, wherein the order of magnitude limit is user selectable.

17. The system of claim 1, wherein the order of magnitude is normalized value associated with the first plurality of tensors.

18. The system of claim 1, wherein the first plurality of tensors is associated with at least one or more layers of the ML model, and wherein the second plurality of tensors is a reference data associated with the ML model.

19. The system of claim 1, wherein the error classification model is generated during a training stage.

20. A system comprising:
a first hardware running a first code generated by a first compiler, wherein the first compiler running on the first hardware is configured to generate a first plurality of tensors associated with one or more machine learning (ML) operations of a ML model; and
a processor configured to
receive the first plurality of tensors associated with the ML model;
receive a second plurality of tensors associated with the ML model, wherein the second plurality of tensors is generated a second code running on a second hardware and executing the one or more ML operations of the ML model, wherein the second code is generated by a second compiler;
generate a plurality of relative errors associated with the first plurality of tensors and the second plurality of tensors;
calculate a plurality of order of magnitude values associated with the first plurality of tensors; and
apply an error classification model to the plurality of relative errors and the plurality of order of magnitude values to classify one or more errors associated with the first plurality of tensors.

21. The system of claim 20, wherein the error classification model is generated based on extracting one or more features from the plurality of relative errors and the plurality of order of magnitude values.

22. The system of claim 20, wherein the processor is configured to generate an image based on the plurality of order of magnitude values and the plurality of relative errors.

23. The system of claim 22, wherein the error classification model is applied to the image to classify the one or more errors.

24. The system of claim 20, wherein the first hardware is a ML accelerator.

25. The system of claim 20, wherein the error classification includes at least one or more of a synchronization error, an improper loading value error, incorrect zero padding error, serialization error, clipping error, incorrect handling of integer quantization format type error, scaling error, incorrect memory mapping error, data access error, memory allocation error, lower-level instruction calls error, orientation error, or splitting or copying error.

26. The system of claim 20, wherein the error classification includes at least one or more of incorrect compilation, incorrect data loading, or a hardware failure.

27. The system of claim 20, wherein the first plurality of tensors is in a channel, height weight format.

28. The system of claim 27, wherein the channel includes red, green, and blue.

29. The system of claim 27, wherein the channel is greater than three.

30. The system of claim 20, wherein the error classification includes a normalized probability associated with each error classification.

31. The system of claim 20, wherein the processor is configured to receive an order of magnitude limit, and wherein a first subset of tensors from the first plurality of tensors with order of magnitude greater than the order of magnitude limit is represented as discarded, wherein the processor is configured to receive a relative error threshold value, wherein a second subset of tensors from the first plurality of tensors with relative errors greater than the relative error threshold value is represented as failed, and wherein the second subset of tensors and the first subset of tensors are mutually exclusive, wherein the processor is configured to represent a third subset of tensors from the first plurality of tensors as passed, wherein the third subset of tensors, the second subset of tensors, and the first subset of tensors are mutually exclusive from one another.

32. The system of claim 31, wherein the relative error threshold value is user selectable.

33. The system of claim 31, wherein the order of magnitude limit is user selectable.

34. The system of claim 20, wherein the order of magnitude is normalized value associated with the first plurality of tensors.

35. The system of claim 20, wherein the first plurality of tensors is associated with at least one or more layers of the ML model, and wherein the second plurality of tensors is a reference data associated with the ML model.

36. A method comprising:
receiving a first plurality of tensors associated with one or more machine learning (ML) operations of a ML model, wherein the first plurality of tensors is generated by a first code running on a first hardware, wherein the first code is generated by a first compiler;
receiving a second plurality of tensors associated with the ML model, wherein the second plurality of tensors is generated by a second compiler generated another code running on a second hardware and executing the one or more ML operations of the ML model;
generating a plurality of relative errors associated with the first plurality of tensors and the second plurality of tensors;
calculating a plurality of order of magnitude values associated with the first plurality of tensors;
extracting one or more features from the plurality of relative errors and the plurality of order of magnitude values; and
generating the error classification model based on the one or more features.

37. The method of claim 36 further comprising generating an image associated with the plurality of relative errors and the calculated order of magnitude associated with the first plurality of tensors, and wherein the one or more features is extracted from the image.

38. The method of claim 36 further comprising implementing a convolutional neural network (CNN) for extracting the one or more features and generating the error classification model.

39. The method of claim 38, wherein the CNN is a ResNet model.

40. The method of claim 36 further comprising implementing a multi-layer perceptron (MLP) or a transformer or a long short-term memory (LSTM) for extracting the one or more features and further for generating the error classification model.

41. The method of claim 36, wherein the error classification includes at least one or more of a synchronization error, an improper loading value error, incorrect zero padding error, serialization error, clipping error, incorrect handling of integer quantization format type error, scaling error, incorrect memory mapping error, data access error, memory allocation error, lower-level instruction calls error, orientation error, or splitting or copying error.

42. The method of claim 36, wherein the error classification includes at least one or more of incorrect compilation, incorrect data loading, or a hardware failure.

43. The method of claim 36, wherein the first plurality of tensors is in a channel, height weight format.

44. The method of claim 43, wherein the channel includes red, green, and blue.

45. The method of claim 36, wherein the error classification includes a normalized probability associated with each error classification.

46. The method of claim 36 further comprising:
receiving an order of magnitude limit;
discarding a first subset of tensors from the first plurality of tensors with order of magnitude greater than the order of magnitude limit;
receiving a relative error threshold value;
representing a second subset of tensors from the first plurality of tensors with relative errors greater than the relative error threshold value as failed, and wherein the second subset of tensors and the first subset of tensors are mutually exclusive; and
representing a third subset of tensors from the first plurality of tensors as passed, wherein the third subset of tensors, the second subset of tensors, and the first subset of tensors are mutually exclusive from one another.

47. The method of claim 46, wherein the relative error threshold value is user selectable, and wherein the order of magnitude limit is user selectable.

48. The method of claim 36 further comprising normalizing the first plurality of tensors to calculate the plurality of order magnitude values.

49. The method of claim 36, wherein the first plurality of tensors is associated with at least one or more layers of the ML model, and wherein the second plurality of tensors is a reference data associated with the ML model.

50. A method comprising:
generating a first plurality of tensors associated with one or more machine learning (ML) operations of a ML model by a first hardware running a first code generated by a first compiler;
receiving a second plurality of tensors associated with the ML model, wherein the second plurality of tensors is generated by a second code running on a second hardware and executing the one or more ML operations of the ML model, wherein the second code is generated by a second compiler;
generating a plurality of relative errors associated with the first plurality of tensors and the second plurality of tensors;
calculating a plurality of order of magnitude values associated with the first plurality of tensors; and
applying an error classification model to the plurality of relative errors and the plurality of order of magnitude values to classify one or more errors associated with the first plurality of tensors.

51. The method of claim 50 further comprising extracting one or more features from the plurality of relative errors and the plurality of order of magnitude values to generate the error classification model.

52. The method of claim 50 further comprising generating an image based on the plurality of order of magnitude values and the plurality of relative errors.

53. The method of claim 52 further comprising applying the error classification model to the image to classify the one or more errors.

54. The method of claim 50, wherein the first hardware is a ML accelerator.

55. The method of claim 50, wherein the error classification includes at least one or more of a synchronization error, an improper loading value error, incorrect zero padding error, serialization error, clipping error, incorrect handling of integer quantization format type error, scaling error, incorrect memory mapping error, data access error, memory allocation error, lower-level instruction calls error, orientation error, or splitting or copying error.

56. The method of claim 50, wherein the error classification includes at least one or more of incorrect compilation, incorrect data loading, or a hardware failure.

57. The method of claim 50, wherein the first plurality of tensors is in a channel, height weight format.

58. The method of claim 57, wherein the channel includes red, green, and blue.

59. The method of claim 50, wherein the error classification includes a normalized probability associated with each error classification.

60. The method of claim 50 further comprising:
receiving an order of magnitude limit;
representing a first subset of tensors from the first plurality of tensors with order of magnitude greater than the order of magnitude limit as discarded;
receiving a relative error threshold value;
representing a second subset of tensors from the first plurality of tensors with relative errors greater than the relative error threshold value as failed, wherein the second subset of tensors and the first subset of tensors are mutually exclusive; and
representing a third subset of tensors from the first plurality of tensors as passed, wherein the third subset of tensors, the second subset of tensors, and the first subset of tensors are mutually exclusive from one another.

61. The method of claim 60, wherein the relative error threshold value is user selectable.

62. The method of claim 60, wherein the order of magnitude limit is user selectable.

63. The method of claim 50, wherein the order of magnitude is normalized value associated with the first plurality of tensors.

64. The method of claim 50, wherein the first plurality of tensors is associated with at least one or more layers of the ML model, and wherein the second plurality of tensors is a reference data associated with the ML model.

65. A system comprising:
a means for receiving a first plurality of tensors associated with one or more machine learning (ML) operations of a ML model, wherein the first plurality of tensors is generated by a first code running on a first hardware, wherein the first code is generated by a first compiler;
a means for receiving a second plurality of tensors associated with the ML model, wherein the second plurality of tensors is generated by a second compiler generated another code running on a second hardware and executing the one or more ML operations of the ML model;
a means for generating a plurality of relative errors associated with the first plurality of tensors and the second plurality of tensors;
a means for calculating a plurality of order of magnitude values associated with the first plurality of tensors;
a means for extracting one or more features from the plurality of relative errors and the plurality of order of magnitude values; and
a means for generating the error classification model based on the one or more features.

66. A system comprising:
a means for generating a first plurality of tensors associated with one or more machine learning (ML) operations of a ML model by a first hardware running a first code generated by a first compiler;
a means for receiving a second plurality of tensors associated with the ML model, wherein the second plurality of tensors is generated by a second code running on a second hardware and executing the one or more ML operations of the ML model, wherein the second code is generated by a second compiler;
a means for generating a plurality of relative errors associated with the first plurality of tensors and the second plurality of tensors;
a means for calculating a plurality of order of magnitude values associated with the first plurality of tensors; and
a means for applying an error classification model to the plurality of relative errors and the plurality of order of magnitude values to classify one or more errors associated with the first plurality of tensors.
